(19) United States
(12) Patent Application Publication
(10) Pub. No.: US 2024/0071231 A1
(43) Pub. Date: Feb. 29, 2024

(54) INFORMATION PRESENTATION DEVICE

(71) Applicant: DENSO CORPORATION, Kariya-city (JP)

(72) Inventors: Masafumi Nohara, Kariya-city (JP); Taro Kobayashi, Kariya-city (JP); Natsuko Miyazaki, Kariya-city (JP); Keiji Okamoto, Kariya-city (JP); Asuka Sakai, Kariya-city (JP); Kazuhiro Matsui, Kariya-city (JP); Haozhou Li, Kariya-city (JP); Jinhae Choi, Kariya-city (JP)

(21) Appl. No.: 18/505,791

(22) Filed: Nov. 9, 2023

Related U.S. Application Data
(63) Continuation of application No. PCT/JP2022/019292, filed on Apr. 28, 2022.

(30) Foreign Application Priority Data
May 12, 2021 (JP) 2021-081241

(51) Int. Cl. G08G 1/16; B60K 35/00; B60Q 9/00; B60W 30/06; B60W 50/14; G08G 1/0967

(52) U.S. Cl. CPC G08G 1/168; B60K 35/00; B60Q 9/008; B60W 30/06; B60W 50/14; G08G 1/0967; B60K 2370/21; B60K 2370/794; B60W 2050/146; B60W 2556/45

(57) ABSTRACT

A human machine interface is configured to select an information display destination from among a plurality of display areas. The HCU acquires a sight line direction of a driver based on an image of an in-vehicle camera. The HCU displays, upon detecting a hop-off action of the driver based on an output signal of an in-vehicle sensor in a situation in which an attention target event such as a puddle, a step, other vehicle or the like exists on a road surface near a door of a driver's seat, in the display area corresponding to the driver's sight line direction, text or an image practically indicating (a) a content of an attention target event or (b) how to deal with a situation.

### CROSS REFERENCE TO RELATED APPLICATION

The present application is a continuation application of International Patent Application No. PCT/JP2022/019292 filed on Apr. 28, 2022, which designated the U.S. and claims the benefit of priority from Japanese Patent Application No. 2021-081241 filed in Japan on May 12, 2021. The entire disclosures of all of the above applications are incorporated herein by reference.

### TECHNICAL FIELD

The present disclosure relates to an information presentation device.

### BACKGROUND

Conventionally, a warning system that provides warning to an occupant of a vehicle has been known.

### SUMMARY

According to an aspect of the present disclosure, an information presentation device is configured to select at least one area from among a plurality of display areas where information is to be displayed to an occupant of a predetermined seat provided in a vehicle. The plurality of display areas includes at least a door display area on a door adjacent to the seat. The information presentation device comprises: a display processing unit configured to display, in at least one of the plurality of display areas, information related to a situation outside the vehicle; and a sight line direction acquisition unit configured to acquire information indicating a sight line direction of the occupant. The display processing unit is configured to change the display area of the information related to the situation outside the vehicle according to the sight line direction of the occupant.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a block diagram of a configuration of an in-vehicle system;

FIG. 2 is a block diagram of an example of a surrounding monitor sensor included in the in-vehicle system;

FIG. 3 is a diagram of an example of combinations of selectable display areas that can be selected by an HCU as information display destinations;

FIG. 4 is a functional block diagram of the HCU;

FIG. 5 is a diagram of an example of an attention-calling image;

FIG. 6 is a flowchart for explaining an example of an operation of the HCU when getting off from a vehicle;

FIG. 7 is a diagram of an example of a summary image notifying the presence of a puddle;

FIG. 8 is a diagram of an example of a summary image notifying the presence of a recessed portion;

FIG. 9 is a diagram of an example of a summary image that notifies the presence of a three-dimensional object;

FIG. 10 is a diagram of an example of a summary image notifying a moving object approaching from behind;

FIG. 11 is a flowchart for explaining an example of the operation of the HCU when getting off from the vehicle;

FIG. 12 is a diagram of an example of a summary image that notifies the presence of a door opening obstacle;

FIG. 13 is a flowchart for explaining an example of the operation of the HCU when getting off from the vehicle;

FIG. 14 is a flowchart for explaining an example of the operation of the HCU when getting off from the vehicle;

FIG. 15 is a diagram of an example of a summary image notifying strong winds;

FIG. 16 is a flowchart for explaining an example of the operation of the HCU when entering a parking lot;

FIG. 17 is a flowchart for explaining an example of the operation of the HCU at the time of starting;

FIG. 18 is a flowchart for explaining an example of the operation of the HCU based on entry into a predetermined permission area;

FIG. 19 is a flowchart for explaining an example of the operation of the HCU as the vehicle approaches the destination;

FIG. 20 is a diagram of a modification of the door display; and

FIG. 21 is a diagram of an example of a variation of a display area.

### DETAILED DESCRIPTION

Hereinafter, examples of the present disclosure will be described.

According to an example of the present disclosure, a system is configured to light up a warning light installed near a doorknob inside a vehicle when the system detects that an occupant attempts to open a door in a situation where a bicycle or an automobile is approaching from behind the vehicle. In this situation, the system outputs a warning sound from a speaker.

The occupant may receive a warning in various situations which include not only an approach of an automobile from behind but also leaving a key fob in the vehicle, a driving electric power for travel of the vehicle left being turned on, and the like. Further, if a driver's seat side door is opened or a seatbelt is unfastened while the driving electric power is on and a position of a gearshift is in a drive range, warning presenting a warning sound and/or a warning light will be performed.

In such manner, a warning is provided to an occupant in response to a variety of events. Therefore, even when a warning sound is output or a warning light is turned on, it is difficult for an occupant to intuitively/readily identify the reason for the warning. As a result, the occupants may be confused/embarrassed. Moreover, if the content of the warning is unknown, the method to deal with the warning is also unknown. Therefore, when a warning sound is output, the occupant has to think about the reason and how to deal with it by him/herself.

According to an example of the present disclosure, in order to address such problems, a configuration is assumable. The configuration outputs a content (reason) of a warning target as a voice message. However, in case of using a voice message, the occupant can identify the cause of the warning only after hearing a key word while listening the message from the beginning. In other words, the voice message cannot immediately/in a relatively short time make the listener to understand the contents of the warning or how to deal with the situation.

According to an example of the present disclosure, a content of the warning may be displayed on a meter display or a center display. However, for example, in a situation of getting off from a vehicle, the occupant is not necessarily looking ahead (i.e., a front) of the vehicle. In a configuration in which detailed information on the content of a warning is always displayed on a fixed display such as a meter display or the like, there is a concern that it is difficult for the occupant to notice the display of the information.

According to an example of the present disclosure, an information presentation device is configured to select at least one area from among a plurality of display areas where information is displayed to an occupant of a predetermined seat provided in a vehicle. The plurality of display areas include at least a door display area formed on a door adjacent to a seat, and the information presentation device includes a display processing unit that displays information related to a situation outside the vehicle in one of the plurality of display areas. A sight line direction acquisition unit acquires information indicating a sight line direction of the occupant. The display processing unit is configured to change a display position of information related to a situation outside the vehicle according to the sight line direction of the occupant.

According to the configuration described above, it is possible to display, for example, text or an image showing a summary of a warning target in the display area corresponding to a sight line direction of the occupant. As a result, it becomes possible to improve recognizability of contents of notification by the occupant.

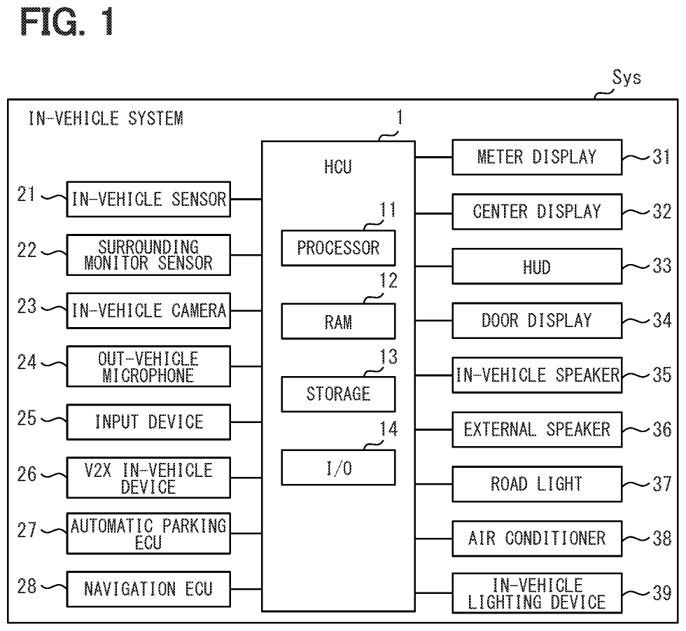

Hereinafter, an embodiment of the present disclosure will be described in the following with reference to the drawings. FIG. 1 is a diagram illustrating an example of a schematic configuration of an HCU 1 as an information presentation device according to the present disclosure. The HCU 1 is a device that controls an operation of HMI (Human Machine Interface), and is an abbreviation for an HMI Control Unit.

In the following, as an example, a case will be described in which information presentation to an occupant in a driver's seat (that is, a driver) is controlled. Since the driver is a user of a vehicle, he or she can also be called as a user. Note that the present disclosure is also applicable to information presentation control to an occupant in a front passenger seat or a navigator in a rear seat. When applying an information presentation target according to the present disclosure to a navigator in a front passenger seat, or the like, the following description can be modified/adapted as appropriate to correspond to a seat to which information is presented. In the following, a case where the driver's seat is provided on a right side of the vehicle will be exemplified. Therefore, the right side of the vehicle corresponds to a seat side direction. The present disclosure may also be applied to a vehicle in which a driver's seat is provided on a left side. In such case, the left side of the vehicle corresponds to the seat side direction.

For convenience, the vehicle on which the HCU 1 is mounted is also referred to as an own vehicle/equipped vehicle. In the following explanation, a front-rear direction, a left-right direction, and an up-down direction are defined with reference to the own vehicle. Specifically, the front-rear direction corresponds to a longitudinal direction of the own vehicle. The left-right direction corresponds to a width direction of the own vehicle. The up-down direction corresponds to a height direction of the own vehicle. From another point of view, the up-down direction corresponds to a direction perpendicular to a plane parallel to the front-rear direction and the left-right direction.

As shown in FIG. 1, the HCU 1 is used by being connected to various in-vehicle devices. For example, the HCU 1 is connected to various in-vehicle sensors 21, a surrounding monitor sensor 22, an in-vehicle camera 23, an out-vehicle microphone 24, an input device 25, a V2X in-vehicle device 26, an automatic parking ECU 27, and a navigation ECU 28. The HCU 1 is also connected to a meter display 31, a center display 32, an HUD 33, a door display 34, an in-vehicle speaker 35, an external speaker 36, a road light 37, an air conditioner 38, and an in-vehicle lighting device 39. Note that HUD as a component name means a head-up display. Further, ECU in the component names is an abbreviation for Electronic Control Unit, and refers to an electronic control device. The V2X is an abbreviation for vehicle to X (everything/something), and indicates a communication technology that connects various things to a vehicle. The “V” in V2X refers to an automobile as the own vehicle, and the “X” refers to various entities other than the own vehicle, such as pedestrians, other vehicles, road equipment, networks, servers and the like.

The HCU 1 and various in-vehicle devices may be connected by a dedicated line or may be connected via an in-vehicle network. Further, an ECU may be interposed at a position between the HCU 1 and the in-vehicle device. For convenience, a configuration including an in-vehicle device connected to the HCU 1 and the HCU 1 will be referred to as an in-vehicle system Sys.

The in-vehicle sensor 21 is a sensor that detects physical state quantities that indicate a state of the vehicle and details of driver's driving operations. Examples of the in-vehicle sensor 21 include a vehicle speed sensor, an acceleration sensor, a steering angle sensor, a gearshift position sensor, an accelerator pedal sensor, a brake pedal sensor and the like. Note that the accelerator pedal sensor is a sensor that detects an amount/force of depression of an accelerator pedal. The brake pedal sensor is a sensor that detects an amount/force of depression of a brake pedal. Further, the in-vehicle sensors also include sensors/switches that detect an operating state of a parking brake and a power source state of the own vehicle. The in-vehicle sensors 21 also include a seat belt sensor and a seating sensor for the driver's seat. The seat belt sensor is a sensor that detects a wearing state of a seat belt. The seating sensor is a sensor that detects that a person is sitting, and is provided for each seat, for example. The seating sensor may be, for example, a pressure sensor embedded in a seating surface of each seat.

In addition, an inner door handle sensor, an in-vehicle microphone, and the like are also included in the concept of the in-vehicle sensor 21. The inner door handle is a door handle provided on an inside of a door of the driver's seat. The inner door handle sensor is a sensor that detects that the driver is gripping the inner door handle, and more preferably detects a grip force (grip pressure). The inner door handle sensor may be a capacitive or pressure sensitive touch sensor provided on the inner door handle. The inner door handle sensor may be an infrared sensor whose detection range is very close to the inner door handle (for example, within 5 cm). The in-vehicle microphone is a microphone that captures a voice spoken by the driver, and is installed near the driver's seat.

The surrounding monitor sensor 22 is a device that collects information about an external environment around the own vehicle. As the surrounding monitor sensor 22, for example, a camera, a millimeter wave radar, a LiDAR (Light Detection and Ranging/Laser Imaging Detection and Ranging), a sonar, and the like can be adopted. The millimeter wave radar is a device that detects a relative position or a relative speed of an object with respect to the own vehicle by transmitting millimeter waves or quasi-millimeter waves in a predetermined direction and analyzing reception data of reflected waves of the transmission waves reflected by the object and returned. The LiDAR is a device that generates three-dimensional point cloud data indicating a position of a reflection point in each detection direction by emitting laser light. The sonar is a sensor that detects obstacles by emitting ultrasonic waves as exploration waves.

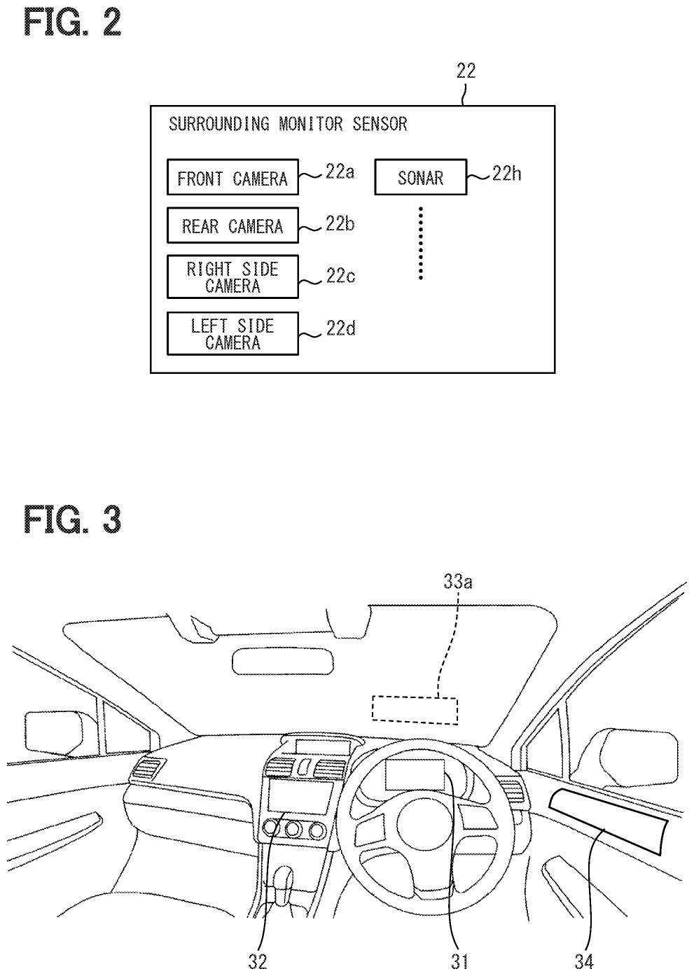

Here, as an example, the in-vehicle system Sys includes a front camera 22a, a rear camera 22b, a right side camera 22c, and a left side camera 22d as surrounding monitor sensors 22, as shown in FIG. 2. The front camera 22a, the rear camera 22b, the right side camera 22c, and the left side camera 22d can be called as surrounding monitoring cameras. Further, the in-vehicle system Sys includes a plurality of sonars 22h as the surrounding monitor sensor 22.

The front camera 22a is a camera that captures images of a front field of the vehicle at a predetermined angle of view. The front camera 22a is disposed, for example, at an upper end of a windshield on the inside of the vehicle, on a front grill, or the like. The rear camera 22b is a camera that captures images of a rear field of the vehicle at a predetermined angle of view. The rear camera 22b is arranged at a predetermined position on a back of the vehicle body, for example, near a rear license plate or near a rear window. In the description of a mounting position of the surrounding monitor sensor 22, “near” a certain member refers to a range within, for example, 30 cm of the relevant member. For example, near the license plate means a range within 30 cm from the license plate.

The right side camera 22c and the left side camera 22d are cameras that capture images of a side field of the vehicle at a predetermined angle of view, and are arranged, for example, at a side mirror, at a predetermined position on the left and right sides of the vehicle body, or near a base of an A pillar. Here, since the driver's seat is provided on the right side of a vehicle compartment, the right side camera 22c corresponds to a vehicle exterior camera whose imaging range includes a proximity of the door of the driver's seat. When the right side camera 22c and the left side camera 22d are not distinguished, they are also simply referred to as side cameras.

The multiple sonars 22h are dispersedly arranged at multiple positions such as a front/rear bumper, a fender, a door panel, and the like. For example, four sonars 22h are dispersedly arranged from a right corner to a left corner of the front bumper. Further, four sonars 22h are dispersedly arranged from the right corner to the left corner of the rear bumper of the own vehicle. Such an arrangement of the sonars 22h allows the in-vehicle system Sys to detect objects present in front or behind the own vehicle. Some of the sonars 22h may be attached to a side sill, the fender, or the door panel so as to emit ultrasonic waves toward the side fields of the vehicle.

Of course, the in-vehicle system Sys may include a millimeter wave radar or LiDAR. Since the sonar 22h, the millimeter wave radar, and the LiDAR are sensors that can acquire distance information to an object, they can be called as distance sensors. Further, the in-vehicle system Sys may include (a) an underfloor sonar whose detection range is below a bottom of the vehicle body, that is, under a floor of the vehicle, or (b) an underfloor camera that captures images of a field under the floor of the vehicle. Underfloor cameras may also be included in the surrounding monitoring cameras.

The various surrounding monitor sensors 22 described above detect, for example, a predetermined detection object to be detected, and also specify a relative position of a detected object with respect to the own vehicle. Then, detection result data indicating a position, a type, and the like of the detected object is sequentially provided to the HCU 1 and the automatic parking ECU 27 (hereinafter referred to as the HCU 1, and the like). Note that the HCU 1 or the automatic parking ECU 27 may have a function of recognizing objects based on image data. Image data also includes a video signal.

The detection object mentioned above is, for example, a pedestrian, an animal other than a human being, other vehicles, a structure installed along a road and the like. Other vehicles include a bicycle, a motorized bicycle, or a motorcycle. The structure arranged along the road may include guard rails, curbs, trees, electric poles, traffic signs, traffic lights and the like. Further, in the present embodiment, as a preferred embodiment, road markings such as lane markings, fallen objects on the road, and the like are also registered as detection objects to be detected by the surrounding monitoring camera. The road marking may also include a parking lot number written in a section of a parking lot. Note that the surrounding monitoring camera such as the front camera 22a may output the video signal to the HCU 1 or the like.

The position of the detected object is expressed, for example, in a vehicle coordinate system, which is a three-dimensional coordinate system with the origin at a predetermined reference point of the own vehicle. An X-axis of the vehicle coordinate system is set to be parallel to a lateral direction of the vehicle, and a positive direction of the X-axis may be set to a right direction along the lateral direction of the vehicle. A Y-axis of the vehicle coordinate system is set to be parallel to a front-rear direction of the vehicle, and a positive direction of the Y-axis may be set to a forward direction along the front-rear direction of the vehicle. The Z-axis is set to correspond to the vehicle height direction. Note that the vehicle coordinate system may be a two-dimensional coordinate system in which the Z-axis is omitted.

The in-vehicle camera 23 is a camera arranged to capture an image of the occupant in the driver's seat. The in-vehicle camera 23 may be arranged on a ceiling portion of the vehicle compartment, such as an overhead console, for capturing an entirety of the vehicle compartment. As the in-vehicle camera 23, for example, a driver status monitor (DSM) can be adopted. The DSM is a device that detects a driver's sight line direction and behavior based on a driver's facial image. The DSM includes, for example, a near-infrared light source, a near-infrared camera, and a control module that controls them. The DSM is installed, for example, on a top surface of a steering column or on a top surface of an instrument panel, with the near-infrared camera facing in the direction where a headrest of the driver's seat is positioned. Note that the camera constituting the DSM may be a visible light camera. The in-vehicle camera 23 outputs driver status information extracted from the driver's image to the HCU 1.

The driver status information includes, for example, a direction of the driver's face, a direction of the driver's sight line, and the like. Note that the HCU 1 may have a function of detecting the driver's sight line direction based on an analysis of an image capturing the driver. In such case, the in-vehicle camera 23 only needs to be configured to output an image of the driver's face to the HCU 1.

The out-vehicle microphone 24 is a microphone placed on an external surface portion of the vehicle. The out-vehicle microphone 24 is installed on or around the door of the driver's seat, e.g., on the A-pillar, so as to easily pick up the voice of the driver who is about to board the vehicle. The out-vehicle microphone 24 converts external sound into an electric signal and outputs the signal to the HCU 1.

The input device 25 is an operation member for receiving instructions from the driver to the in-vehicle system Sys. The input device 25 may be a mechanical switch (so-called steering switch) provided on a spoke portion of a steering wheel, or may be an audio input device that recognizes the content of the driver's utterance. Further, the input device 25 may be a touch panel laminated on a display panel of a display provided on the instrument panel, such as the center display 32, for example. The input device 25 outputs an electric signal corresponding to an operation performed thereon by a user to the HCU 1 as a user operation signal. The user operation signal includes information that indicates details of the operation performed by the user.

The V2X in-vehicle device 26 is a communication module for the own vehicle to perform wireless communication with other devices. The V2X in-vehicle device 26 is configured to be capable of performing cellular communication, which is wireless communication based on, for example, LTE (Long Term Evolution), 4G, 5G, or the like. The V2X in-vehicle device 26 acquires weather information such as a probability of precipitation for time slots from an external server, a roadside device, or the like. Further, the V2X in-vehicle device 26 may be configured to be capable of performing short-range communication that is communication based on Wi-Fi (registered trademark) or Bluetooth (registered trademark). In addition, the V2X in-vehicle device 26 may be configured to be capable of performing communication based on a short range communication standard for vehicles, such as DSRC (Dedicated Short Range Communications). The V2X in-vehicle device 26 includes an antenna that can transmit and receive radio waves of frequencies used in various communication standards, an IC that performs modulation and demodulation, and the like.

The automatic parking ECU 27 is an ECU that automatically parks the own vehicle at a target parking position based on information such as an image of the vehicle surroundings and the position of a detected object inputted from the surrounding monitor sensor 22. The automatic parking ECU 27 automatically controls a wheel angle and a travel speed from the point where execution of the automatic parking is instructed by the driver to the target parking position, and autonomously moves the own vehicle to the target parking position. Automatic parking here also includes a mode in which the driver autonomously parks the vehicle by remote control using a device such as a smartphone that is associated with the vehicle. For example, the automatic parking ECU 27 may be configured to perform control to autonomously drive the vehicle toward the target parking position on a condition that the user as a driver presses a predetermined automatic parking button displayed on the smartphone.

In addition, the automatic parking ECU 27 may also be configured to be capable of performing automatic exit control from the parking lot in which the own vehicle in a parked condition is turned on to autonomously travel to a driver specified position or to a position close to the driver, which is triggered by an instruction signal from a portable terminal associated with the own vehicle. The automatic parking ECU 27 may also be configured to be capable of performing automatic parking control and automatic exit control on a condition that the driver is within a predetermined distance from the own vehicle, for example. The automatic parking ECU 27 may also perform automatic parking and automatic exit in cooperation with infrastructure equipment provided in the parking lot.

The navigation ECU 28 is a device that displays a map image and provides route guidance according to a current position of the vehicle. The navigation ECU 28 includes, for example, a map database and a GNSS (Global Navigation Satellite System) receiver. The GNSS receiver is a device that sequentially (for example, every 100 milliseconds) detects the current position of the GNSS receiver by receiving positioning signals from a plurality of positioning satellites. The map data used by the navigation ECU 28 includes position information of parking lots associated with facilities, and the like. The navigation ECU 28 outputs position information of the own vehicle and surrounding map information to the HCU 1. In a preferred embodiment, the navigation ECU 28 outputs a signal to the HCU 1 indicating that the own vehicle has entered a facility-side parking lot, which is a parking lot associated to a facility, based on the position information of the own vehicle and the map data.

The meter display 31 is a display arranged in an area positioned right in front of the driver's seat on the instrument panel. As the display, a liquid crystal display, an organic EL (Electro-Luminescence) display, and the like can be used.

The center display 32 is a display arranged approximately at a center in the vehicle width direction on the instrument panel. For example, the center display 32 is placed near a shift lever/shift button. The center display 32 may be a display placed in a center console.

The HUD 33 is a device that projects a virtual image that can be perceived by the driver by projecting an image light onto a predetermined area of the windshield based on control signals and video data input from the HCU 1, the navigation ECU, and the like. The HUD 33 displays an image superimposed on a scenery in front of the vehicle. A sign 33a in FIG. 3 indicates an image display area (i.e., a projection area) by the HUD 33.

The door display 34 is a display provided on the door of the driver's seat. For example, the door display 34 is arranged on a door trim of the door of the driver's seat, i.e., along a lower end of a window frame thereof, as shown in FIG. 3. The door display 34 may include a curved display surface that follows the shape of the door trim. As the door display 34, for example, a light-transmitting skin display is adoptable. The light-transmitting skin display is a display that has an artificial skin that transmits light. The door display 34 can be realized using an organic EL display, a liquid crystal panel, or the like. The size of a display area of the door display 34 is preferably set to at least 3 cm in height and 5 cm in width so that a variety of texts or summary images can be displayed. For example, the door display 34 is set to approximately 5 cm in height and 20 cm in width. Vertical and horizontal dimensions described here are concepts for explaining the size of the display area of the door display 34, and the vertical direction corresponds to the vehicle height direction or the vehicle width direction, and the horizontal direction corresponds to the longitudinal direction of the vehicle. A display screen of the door display 34 corresponds to the door display area.

Each of the meter display 31, the center display 32, the HUD 33, and the door display 34 displays an image according to a signal input from the HCU 1. The meter display 31 and the HUD 33 correspond to a device that forms a front display area that is a display area positioned in the front direction of the driver's seat. The center display 32 corresponds to a device that provides a passenger seat side display area positioned closer to a passenger seat than the front display area. The HCU 1 of the present disclosure is configured to be capable of selectively employing the front display area, the passenger seat side display area, and the door display area as display destinations for information images. Each of the display areas is a display area formed by a different device, and is dispersedly arranged at a separation distance of 5 cm or more in a real space inside the vehicle.

The in-vehicle speaker 35 is a speaker provided inside a vehicle compartment. The in-vehicle speaker 35 is provided, for example, on the instrument panel. The external speaker 36 is a speaker provided on an external surface portion of the vehicle. The external speaker 36 is arranged at the bottom of the vehicle body or near the door of the driver's seat. The external speaker 36 is a speaker mainly used for communicating with a person near the vehicle. The external speaker 36 is also used for the driver inside the vehicle to call out to an animal such as a cat that has crawled under the vehicle body, or to make a sound for moving the animal. The in-vehicle speaker 35 and the external speaker 36 each convert an electric signal input from the HCU 1 into sound and output the sound. The expression “sound” also includes voice, music and the like.

The road light 37 is a lighting device that illuminates a road surface near the door of the driver's seat. The road light 37 is provided, for example, in the side mirror on the driver's seat side, at a lower end of the door of the driver's seat, or near the side sill on the driver's seat side. The road light 37 includes a light source element such as an LED. Based on the instruction signal from the HCU 1, the road light 37 illuminates a predetermined area of the road surface with a color and brightness according to the signal.

The air conditioner 38 is a device that outputs conditioned air, which is air whose temperature is adjusted according to a set temperature, from an outlet provided in the vehicle. The air conditioner 38 is configured to be capable of performing heating and cooling using a heat pump cycle that can perform heating and cooling using one refrigerant circuit, for example. Further, the air conditioner 38 has a function as an aroma shooter that injects a preset fragrance into the vehicle compartment. For example, the air conditioner 38 is configured to be capable of outputting a scent such as lemon or mint that is expected to have a refreshing effect into the vehicle compartment.

The in-vehicle lighting device 39 is a lighting device arranged in the vehicle compartment. The in-vehicle lighting device 39 can be a lighting device in which a plurality of light sources are arranged in a line along joints and edges of components, e.g., in the door trims and on the instrument panel. The in-vehicle lighting device 39 is configured, for example, so that light leaks out from the joints of interior components. Further, the in-vehicle lighting device 39 may be configured as indirect lighting that indirectly illuminates feet and the like. The in-vehicle lighting device 39 may be configured as a so-called ambient light.

<About the Configuration of HCU 1>

The HCU 1 is a computer that integrally controls the presentation of information to the driver using various displays/projectors and the like. The HCU 1 is configured as a computer including a processor 11, a RAM (Random Access Memory) 12, a storage 13, a communication interface 14 (I/O in the drawing), a bus line connecting these components, and the like.

The processor 11 is, for example, an arithmetic core such as a CPU (Central Processor) or the like. The processor 11 executes various processes by accessing the RAM 12. The RAM 12 is a volatile memory. The communication interface 14 is a circuit for the HCU 1 to communicate with other devices. The communication interface 14 may be realized using analog circuit elements, ICs, or the like.

The storage 13 includes a non-volatile storage medium such as a flash memory. The storage 13 stores a display control program that is a program for causing the computer to function as the HCU 1. Execution of the display control program by the processor 11 corresponds to performing a display control method that is a method corresponding to the display control program. Further, data indicating a driver's schedule, personality, and the like is registered in the storage 13.

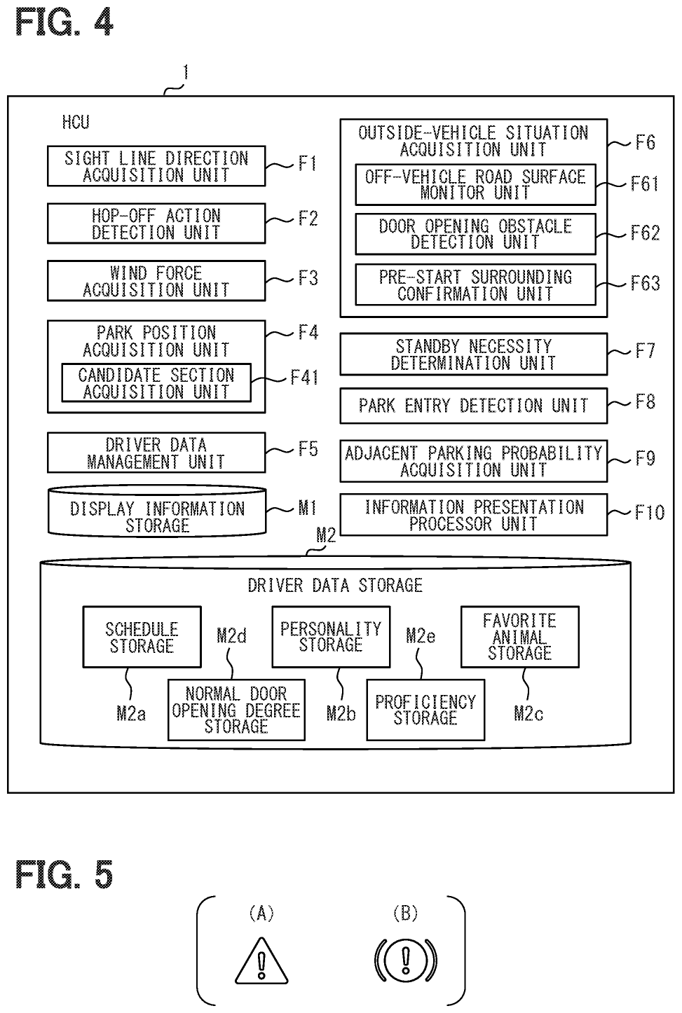

The HCU 1 provides each of functional units shown in FIG. 4 by the processor 11 executing the display control program stored in the storage 13. That is, the HCU 1 includes a sight line direction acquisition unit F1, a hop-off action detection unit F2, a wind force acquisition unit F3, a park position acquisition unit F4, a driver data management unit F5, and an outside-vehicle situation acquisition unit F6. The HCU 1 also includes a standby necessity determination unit F7, a park entry detection unit F8, an adjacent parking probability acquisition unit F9, and an information presentation processor unit F10. The park position acquisition unit F4 includes a candidate section acquisition unit F41 as a sub-functional unit. The outside-vehicle situation acquisition unit F6 includes an off-vehicle road surface monitor unit F61, a door opening obstacle detection unit F62, and a pre-start surrounding confirmation unit F63 as sub-functional units. Data acquired or generated by each of the functional units is temporarily stored in a memory such as the RAM 12 and the like, and used by reference by other functional units.

The HCU 1 also includes a display information storage M1 and a driver data storage M2. The display information storage M1 stores display data for each of predetermined notification target events. A notification target event is an event that occurs outside the vehicle and should be notified to the driver, and includes, for example, an event that may impair the driver's safety or convenience. Note that the notification target event regarding safety corresponds to an event of attention/warning target.

The contents of display data is, for example, an outline of the notification target event, or a recommended action indicating a behavior pattern that the driver should take in response to the event. The display data may be text showing a summary or the recommended action, or may be an image schematically showing the summary or the recommended action.

The summary image, i.e., an image schematically showing the summary, is an image that includes image elements that indicate the contents of an attention target and the contents of proposal. The summary image is different from a mere attention-calling image that does not include specific details of the attention target. The attention-calling image refers to an icon image that is a combination of an exclamation mark and a figure such as a circle or a triangle, as shown in FIGS. 5A and 5B. The attention-calling image corresponds to an image in which it is unclear what the driver should pay attention to or what he should do even when he or she just looks at it. The summary image is, on the other hand, an image that includes image elements that indicate an attention target or how to deal with a situation (i.e., the recommended action). Details of the recommended actions and the summary images for the attention target event to which the driver should pay attention will be described later.

The driver data storage M2 stores personal data such as the driver's schedule and the like. The driver data storage M2 includes a schedule storage M2a, a personality storage M2b, a favorite animal storage M2c, a normal door opening degree storage M2d, and a proficiency level storage M2e as more detailed elements. The schedule storage M2a is a storage area for driver schedule data. The personality storage M2b is a storage area for data indicating the driver's personality, such as whether the driver's character is clean, impatient, methodical, rough-around-the-edges or the like. The favorite animal storage M2c is a storage area for data indicating the driver's favorite animal. The favorite animal storage M2c may be integrally provided with the personality storage M2b.

The normal door opening degree storage M2d is a storage area for data indicating a normal opening degree of the door, which is a degree of opening of the door on a daily basis. The normal opening degree of the door may be learned based on the driver's vehicle usage history, or may be registered by the driver. For example, the normal opening degree of the door may be determined based on the door opening/closing operation performed by the driver during a registration mode period. The normal opening degree of the door may be expressed by an angle or the like. Note that the normal door opening degree storage M2d may store, in addition to the normal opening degree of the door, a speed at which the door opens, and the like in association with the normal opening degree of the door. The proficiency level storage M2e is a storage area for data indicating a level of driving skill, in other words, the proficiency level of driving. The level of driving skill may be automatically determined based on the frequency of sudden braking or sudden steering, the number of turns when parking, and the like, or may be manually input by the driver.

The display information storage M1 and the driver data storage M2 can be realized using a storage area included in the storage 13. Note that the driver data storage M2 may be realized using a part of the storage area included in the RAM 12.

The sight line direction acquisition unit F1 acquires the driver's sight line direction, a face direction, and a head position based on the output signal of the in-vehicle camera 23. Here, as an example, it is assumed that the in-vehicle camera 23 recognizes the direction of the driver's sight line, and the like, and outputs the recognition result, but the present disclosure is not limited thereto. The sight line direction acquisition unit F1 may analyze the captured image of the in-vehicle camera 23 to identify the sight line direction and the like.

The hop-off action detection unit F2 is configured to detect the driver's action of getting/hopping off from the vehicle, which may also be denoted as getting out of the vehicle. The hop-off action corresponds to a preliminary action of getting off from (or getting out of) the vehicle by opening the door of the vehicle. The hop-off action may be read/understood as a set-to-hop-off action to prepare for the hop off from the vehicle. Detecting the hop-off action corresponds to determining that the driver is about to open the door. The hop-off action includes, for example, setting the shift lever to a parking range, turning off the driving electric power, turning on a parking brake, releasing a seat belt, placing a hand on the inner door handle, unlocking the door and the like. Other than the above, the driver's turning his or her body toward the door or uttering a hop-off phrase, which is a phrase indicating arrival at the destination, can also be adopted as the hop-off action. Hop-off phrases include phrases that indicate arrival at a destination, such as “I've arrived,” and phrases that urge fellow occupant(s) to get/hop off from the vehicle, such as “I'm getting off” and the like Various actions/behaviors are identifiable based on output signals from various in-vehicle sensors/ECUs, such as a gearshift position sensor, a power switch, an image from the in-vehicle camera 23, a seatbelt sensor, a door lock sensor, an in-vehicle microphone and the like. The hop-off action detection unit F2 may determine that the driver is about to hop off from the vehicle by combining some of the above-described actions.

The wind force acquisition unit F3 is configured to acquire the strength of the wind outside the vehicle compartment. Here, a wind speed is used as an index indicating the strength of the wind (that is, wind force), but it is not limited thereto. The strength of the wind may be expressed in multiple levels, such as levels 1 to 3, for example. The wind force acquisition unit F3, in cooperation with, for example, the V2X in-vehicle device 26, acquires the wind speed at the current position from a server that handles weather information. Note that the wind force acquisition unit F3 may acquire the wind speed based on the magnitude of the sound of the wind acquired by the out-vehicle microphone 24. The sound of the wind is detected as noise by the out-vehicle microphone 24, and the stronger the wind is, the higher the noise level tends to be. Therefore, the wind force acquisition unit F3 may determine the wind speed based on the noise level output by the out-vehicle microphone 24.

The park position acquisition unit F4 is configured to acquire a target parking position that is a target position of parking by the automatic parking ECU 27 or the driver. For example, the park position acquisition unit F4 automatically determines the target parking position based on the recognition result of the outside of the vehicle by the surrounding monitor sensor 22. The park position acquisition unit F4 may determine the target parking position based on the driver's operation signal output from the input device 25 in cooperation with the HCU 1. Specifically, the HCU 1 may present candidates of parking space to the driver based on a recognition result of the outside of the vehicle by the surrounding monitor sensor 22, and may finally determine the target parking position according to the driver's operation on the input device 25. In addition, the target parking position may also be determined based on vacant parking section information received via wireless communication from a parking lot device that is an infrastructure equipment provided in the parking lot. The parking lot device corresponds to a kind of a roadside device. In one aspect, the target parking position corresponds to a target point at which the automatic parking ECU 27 performs automatic parking or parking assistance. Further, the target parking position may be a target point when the driver manually parks the vehicle.

The candidate section acquisition unit F41 acquires position information where a candidate section, which is a parking section where a vehicle can park, exists in a parallel parking lot, which is a parking lot having a plurality of parking sections for a plurality of vehicles to park in parallel. The above-mentioned facility-side parking lot may also fall under the category of parallel parking lot depending on the arrangement of the parking sections. The information on the candidate section may be generated based on the detection result of the surrounding monitor sensor 22, or may be acquired by wireless communication with the parking lot device. The parking lot device, for example, distributes information regarding vacant parking sections in the parking lot. Further, the parking lot device may distribute data indicating a use probability for each section. The use probability for each section is determined statistically from past usage history. For example, the use probability may be higher for a section closer to the entrance of a facility, and the use probability may be lower for a section relatively farther away from the entrance of the facility. Use probability information for each section may indicate the use probability for each time slot. According to such data structure, the candidate section acquisition unit F41 can identify areas that are vacant or sparsely parked during a specific time slot such as noon.

The driver data management unit F5 acquires driver's personal information and stores the information in the driver data storage M2. The personal information includes, for example, some or all of the driver's schedule, personality, favorite animal, a normal opening degree of the door, level of driving skill, and the like. The driver's schedule can be acquired from an external server that holds driver information or from the driver's smartphone, which is enabled in cooperation with the V2X in-vehicle device 26. The driver's personality and a normal opening degree of the door may be learned based on the driver's vehicle usage history. The usage history can include a driving history that is a history of driving operations. If the own vehicle is a vehicle provided for a sharing service, the driver data management unit F5 acquires the next user's information from a predetermined external server based on the user change, and updates/rewrites the data saved in the driver data storage M2.

The outside-vehicle situation acquisition unit F6 recognizes a situation outside the vehicle, in other words, the surrounding environment, based on the output signal of the surrounding monitor sensor and the data received by the V2X in-vehicle device 26. For example, the outside-vehicle situation acquisition unit F6 recognizes the surrounding environment based on images from a surrounding monitoring camera. The surrounding environment here includes the positions and moving speeds of other moving objects around the own vehicle, the shapes and sizes of surrounding objects, and the like. The outside-vehicle situation acquisition unit F6 also acquires road surface markings such as lane markings provided on the road surface and road surface conditions based on the image data of the surrounding monitoring camera. Of course, the outside-vehicle situation acquisition unit F6 may acquire detection results from each of the plurality of surrounding monitor sensors 22 and combine them to recognize the position and kind of an object existing around the vehicle. Further, the outside-vehicle situation acquisition unit F6 may identify the surrounding environment using other vehicle information received from other vehicles by the V2X in-vehicle device 26, dynamic map information received from a roadside device through road-to-vehicle communication, and the like. The dynamic map information indicates the position, moving speed, and the like of a moving object.

In a preferred embodiment, the outside-vehicle situation acquisition unit F6 dynamically generates a three-dimensional map around the own vehicle and around the target parking spot based on the detection results of the surrounding monitor sensor 22. The three-dimensional map corresponds to map data in which objects detected by the surrounding monitor sensor 22 are mapped onto a virtual space corresponding to the vehicle coordinate system.

Further, the outside-vehicle situation acquisition unit F6 detects a notification target event outside the vehicle compartment based on the output data of the surrounding monitor sensor 22 and the like. The notification target event may include, for example, other moving objects approaching the own vehicle, three-dimensional objects that are likely to come into contact with the own vehicle, and road surface irregularities or steps that may affect a vehicle body posture. The off-vehicle road surface monitor unit F61 and the door opening obstacle detection unit F62 are functional elements that detect notification target events according to the situation.

The off-vehicle road surface monitor unit F61 determines whether a notification target event occurs at a hop-off spot, which is an area of a road surface where the driver may land (i.e., may put his/her feet on) when hopping off from the vehicle, based on images from the surrounding monitoring camera, such as a side camera on the driver's seat side (that is, the right side camera 22c), for example. The hop-off spot corresponds to an area of a road surface within a predetermined distance (for example, 1 m) from the door of the driver's seat. The notification target event that may occur at the hop-off spot include having puddles, recesses such as gutters, three-dimensional objects such as steps, trash and the like. For example, a low fence with a height of less than 0.5 m, a road cone, a large stone, and the like can also be included in the notification target event at the hop-off spot. For convenience, among three-dimensional objects, a three-dimensional object whose height is less than a predetermined threshold value (for example, 0.2 m) and whose height is lower than the lower end of a door or the bottom of the vehicle body is also referred to as a low-profile, three-dimensional object. The low-profile, three-dimensional object corresponds to a three-dimensional object that does not come into contact with a door when the door is opened or closed. Here, as an example, the HCU 1 detects a notification target event such as a puddle based on a camera image. Of course, detection (recognition) of water puddles and the like may be performed by a surrounding monitoring camera or another ECU. The off-vehicle road surface monitor unit F61 starts searching for a door opening obstacle, for example, based on the vehicle speed becoming less than or equal to a predetermined monitoring start threshold value. The monitoring start threshold value can be set to, for example, 0 km/h, 5 km/h, 10 km/h, and the like.

The door opening obstacle detection unit F62 determines whether a three-dimensional object that possibly comes into contact with the door when the driver seat door is opened exists within a predetermined distance from the driver's door, based on the captured image of the side camera on the driver's seat side and the detection results of the sonar 22h. A three-dimensional object that may possibly come into contact with the driver's door is also referred to herein as a door opening obstacle. Door opening obstacles include, for example, other vehicles, utility poles, and walls. The door opening obstacle detection unit F62 detects the presence of a door opening obstacle within 0.75 m from the driver's door based on the output signal of the sensor. Note that obstacles to opening the door are not limited to stationary objects. Pedestrians existing within the movable range of the driver's door can also be included in door opening obstacles.

The door opening obstacle detection unit F62 also starts searching for a door opening obstacle, for example, based on the vehicle speed becoming less than or equal to a predetermined monitoring start threshold value. Further, when the park position acquisition unit F4 identifies the target parking spot, the door opening obstacle detection unit F62 determines whether or not there is a door opening obstacle based on the detection result of the surrounding monitor sensor 22 in the proximity of the target parking spot. That is, the door opening obstacle detection unit F62 determines, before arriving at the target parking position (that is, in advance), whether the target parking position is in a narrow environment where opening and closing of the driver's seat side door will be hindered. The door opening obstacle detection unit F62 outputs the determination result regarding the presence or absence of a door opening obstacle to the information presentation processor unit F10.

The pre-start surrounding confirmation unit F63 detects animals or pedestrians existing in a nearby area of the own vehicle based on the output signal of the surrounding monitor sensor 22 that is activated based on the fact that the driving electric power is set to on. The nearby area mentioned above is an area within 0.3 m from the vehicle body, and includes an area around tires and the proximity of the bumper. Further, the nearby area may include under the floor. For example, the pre-start surrounding confirmation unit F63 compares an image outside the vehicle taken by a surrounding monitoring camera during parking with an image outside the vehicle acquired after the driving electric power is turned on, and detects animals like cats or pedestrians (children) existing in the nearby area. The pre-start surrounding confirmation unit F63 may be configured to detect a small animal such as a cat that has crawled under the vehicle body based on the detection results of an underfloor camera or an underfloor sonar.

In addition, the outside-vehicle situation acquisition unit F6 determines, based on the output signal of the surrounding monitor sensor 22, whether there is another moving object that is scheduled to pass by the side of the vehicle on the driver's seat side. Another moving object that is scheduled to pass by the side of the vehicle on the driver's seat side corresponds to a notification target object acting as a notification target event. For example, the outside-vehicle situation acquisition unit F6 extracts a moving object (hereinafter referred to as an approaching object) such as another vehicle or a pedestrian moving toward the own vehicle from behind or in front of the own vehicle. Then, based on the moving speed, moving direction, and position information of the approaching object, the outside-vehicle situation acquisition unit F6 determines whether the approaching object passes within a predetermined distance (for example, 1.5 m) from the door of the driver's seat within a predetermined time such as 10 seconds. The outside-vehicle situation acquisition unit F6 detects an approaching object that satisfies the above-described conditions as a notification target object. Note that the outside-vehicle situation acquisition unit F6 may exclude the approaching object from the notification target object, when (a) the detected approaching object is scheduled to pass by the passenger seat side or (b) it is scheduled to pass by the side sufficiently far from the door of the driver's seat.

Further, the outside-vehicle situation acquisition unit F6 determines whether or not there is a strong wind outside the vehicle based on the wind speed acquired by the wind force acquisition unit F3, and outputs the determination result to the information presentation processor unit F10. The outside-vehicle situation acquisition unit F6 sequentially acquires surrounding environment information, which is information about the surrounding environment, based on, for example, the vehicle speed being less than or equal to the monitoring start threshold value. Acquisition of the information mentioned in the above includes generation/detection by internal calculations. The state where the vehicle speed is less than or equal to the monitoring start threshold value includes a stop state of the vehicle.

The standby necessity determination unit F7 determines whether the situation is a door open standby recommended situation, i.e., a situation in which postponing of door opening is recommended based on the surrounding environment information acquired by the outside-vehicle situation acquisition unit F6. That is, the situation is determined as the one in which the driver should wait in standby for an appropriate moment of opening the door. For example, the door open standby recommended situation includes (i) a situation in which there is another moving object scheduled to pass near the door of the driver's seat, (ii) a situation in which a person is getting off from a parallel parked vehicle that is parked alongside the own vehicle on the driver's seat side, and the like. For example, the standby necessity determination unit F7 determines that the situation corresponds to the door open standby recommended situation when the outside-vehicle situation acquisition unit F6 is detecting an approaching object that is scheduled to pass by the door of the driver's seat. Further, by analyzing the image of the side camera on the driver's seat side, the standby necessity determination unit F7 determines that the situation corresponds to the door open standby recommended situation when detecting that a person is about to get off from the parallel parked vehicle, e.g., when the door of a passenger seat is moving.

The park entry detection unit F8 detects that the own vehicle has entered the facility-side parking lot based on a signal from the navigation ECU 28. Whether or not the vehicle has entered the facility-side parking lot is determinable, for example, by comparing a vehicle location information with the map data. Whether the own vehicle has entered the facility-side parking lot based on the own vehicle position information and the map data may either be performed by the navigation ECU 28 or by the park entry detection unit F8. The functional arrangement in the in-vehicle system Sys is changeable as appropriate. In addition, the park entry detection unit F8 may detect entering the facility-side parking lot based on receiving a wireless signal from the parking lot device. Alternatively, entering the facility-side parking lot may be detected based on the detection of a plurality of parking section lines by analyzing images from a surrounding monitoring camera.

The adjacent parking probability acquisition unit F9 acquires an adjacent parking probability in a state where the park entry detection unit F8 has detected entering the facility-side parking lot and the candidate section acquisition unit F41 has acquired a candidate section. The adjacent parking probability is a probability at which another vehicle parks in an adjacent parking section that is a parking section on the driver's seat side among the parking sections adjacent to the candidate section. The adjacent parking probability is calculable based on data indicating the use probability for each section provided by wireless communication from the parking lot device. Further, the adjacent parking probability may be calculated based on parking history data when the own vehicle parked in the candidate section in the past. The parking history data is data that associates (i) the position information of the parking section where the own vehicle has parked with (ii) (a) time when the own vehicle has parked, (b) time when the vehicle has left the parking section, and (c) whether or not another vehicle is parked in the adjacent section on the driver's seat side at the time of starting from the parking section. Whether or not another vehicle is parked in the adjacent section at the time of starting from the parking section is determinable based on the detection result of the surrounding monitor sensor 22.

The information presentation processor unit F10 displays an image indicating (a) the contents of the notification target event detected by the outside-vehicle situation acquisition unit F6 or (b) the recommended action corresponding to the detected event in the display area positioned in the direction of the driver's sight line which has been acquired by the sight line direction acquisition unit F1. Note that the concept of displaying an image includes displaying text. Data for displaying the recommended action or the like corresponding to the detected event is acquired by referring to the display information storage M1. The display area positioned in the sight line direction can be understood as the display (i.e., a position where an event of displaying relevant information is happening) closest to the sight line direction. The information presentation processor unit F10 corresponds to a display processing unit.

For example, when the driver's sight line is directed toward the door of the driver's seat or the outside of the door at the time of detecting the hop-off action by the hop-off action detection unit F2, the door display 34 displays the contents of the notification target event being detected or the recommended action. Alternatively, when the driver's sight line is directed toward the proximity of the shift lever, the center display 32 displays the contents of the notification target event being detected or the recommended action. When the driver's sight line is directed toward the front of the vehicle, the meter display 31 or the display area 33a of the HUD 33 displays the contents of the notification target event being detected or the recommended action.

In such manner, the information presentation processor unit F10 changes a display position of the information according to the direction of the driver's sight line. In addition, in the starting situation where the own vehicle is about to start traveling, information is displayed in a display area positioned in the sight line direction (a) at the timing of switching the driving electric power from off to on, or (b) at the timing of switching the position of the gearshift from (i) the parking range to (ii) the drive range or the reverse range. That is, in the starting situation, various types of information are chosen to be displayed in the display area/display device corresponding to the direction of the sight line at the time of detecting a predetermined starting action having been performed based on the output signal of the in-vehicle sensor 21.

Note that the display area corresponding to the direction of the sight line refers to a display area arranged at a position within the driver's stable field of view. The stable field of view is a range in which a focal point is quickly stabilized even when the fixation point is moved, and is an elliptical range of ±80 degrees in the horizontal direction and ±60 degrees in the vertical direction. Further, if there are multiple display areas included in the stable field of view, that is, multiple display position candidates, the display area closest to the center of the sight line among those candidates is selected as an information output destination. For example, the information presentation processor unit F10 preferentially selects a display area within the driver's effective field of view as the information display destination. The effective field of view is a range in which objects are recognized, and is generally considered as a range of ±35 degrees in the horizontal direction and ±30 degrees in the vertical direction centered on the fixation point. Although the direction of the sight line acquired by the sight line direction acquisition unit F1 may include an error, the direction of the sight line acquired by the sight line direction acquisition unit F1 is expected to fall within an angle of the actual driver's effective field of view. Therefore, by displaying the contents of the detected event or the recommended action corresponding to the detected event in the display area positioned in the direction of the detected sight line, it is possible to make it easy for the driver by him/herself to recognize the action he or she should take.

<Example of Application to Hop-Off Situation (Part 1)>

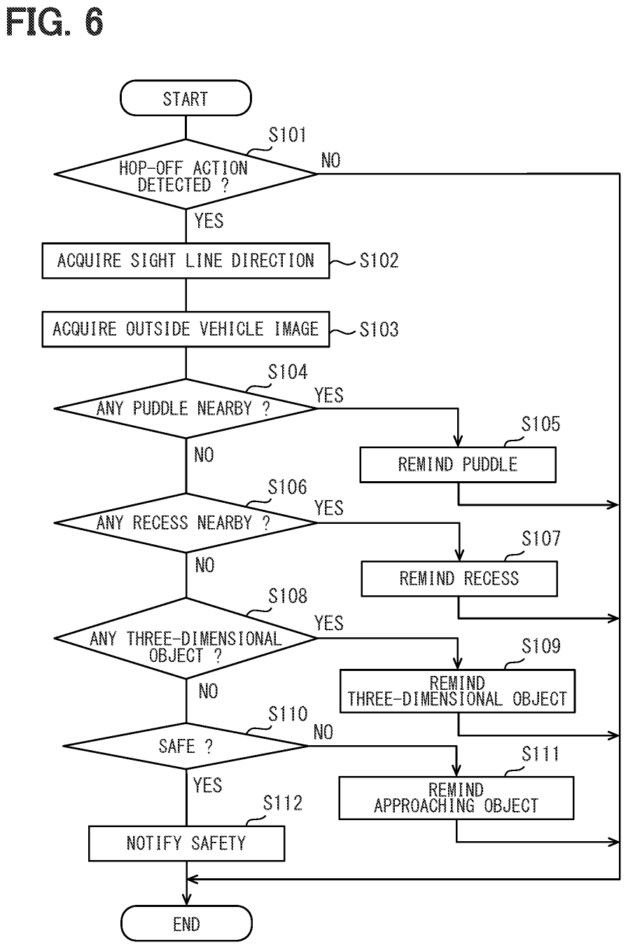

Here, using a flowchart in FIG. 6, an operation of the HCU 1 in a situation where a driver parks and gets off from a vehicle will be explained. For convenience, the series of processes shown in FIG. 6 will be referred to as a display control process at a time of getting off from a vehicle. As an example, the display control process at a time of getting off from a vehicle includes steps S101 to S112. The number of steps and processing order of the flowchart shown in FIG. 6 can be changed as appropriate. The display control process at a time of getting off from a vehicle shown in FIG. 6 is sequentially performed at a predetermined execution cycle, for example, while the travel speed of the own vehicle is lower than or equal to a predetermined threshold value. The number of steps and processing order of various flowcharts of the present disclosure can be changed as appropriate.

First, in step S101, the hop-off action detection unit F2 determines whether or not the driver has performed a hop-off action. If a hop-off action is not detected, a negative determination is made in step S101, and this flow ends. On the other hand, if a hop-off action is detected, an affirmative determination is made in step S101 and the process shifts to step S102. Note that this flow may be started using, as a trigger, a detection of the driver's hop-off action by the hop-off action detection unit F2.

In step S102, the sight line direction acquisition unit F1 acquires the driver's sight line direction, and the process shifts to step S103. In step S103, the off-vehicle road surface monitor unit F61 acquires an image outside the vehicle from the surrounding monitoring camera, and the process shifts to step S104.

In step S104, the off-vehicle road surface monitor unit F61 determines whether there is a puddle at the hop-off spot by analyzing the image acquired in step S103. Note that, as described above, detection of a notification target event based on image analysis may be performed by another ECU specialized in image analysis functions, such as an ECU included in a camera, for example.

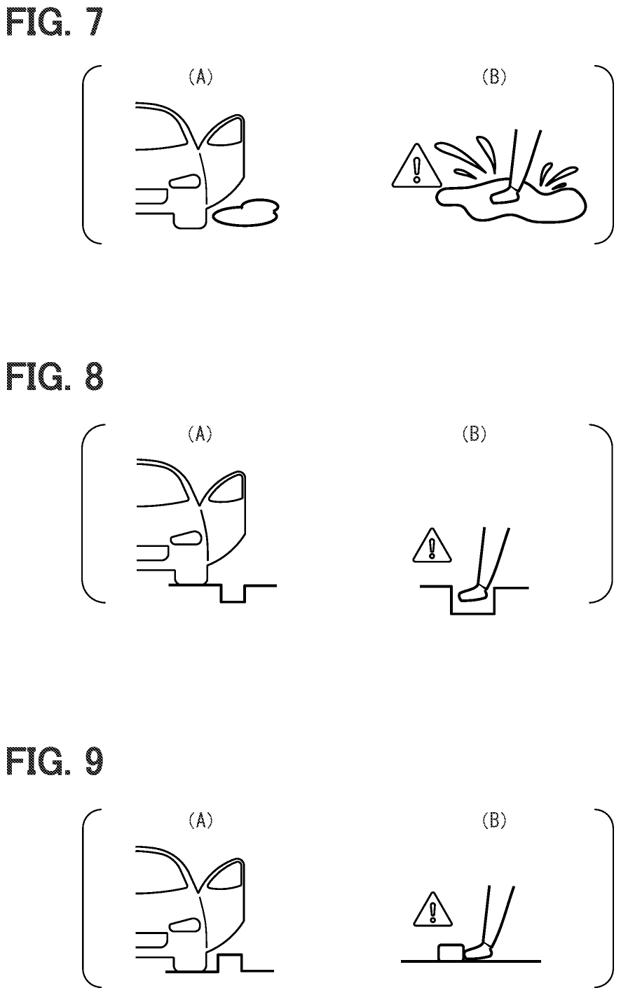

If there is a puddle at the hop-off spot, an affirmative determination is made in step S104, and step S105 is performed. On the other hand, if there is no puddle at the hop-off spot, a negative determination is made in step S104 and step S106 is performed. In step S105, the information presentation processor unit F10 displays text or a summary image indicating that there is a puddle near the door in the display area corresponding to the driver's sight line direction acquired in step S102. Text can also be read as message or character string. For example, when the driver is facing toward the driver's seat door, a notification image of a puddle is displayed on the door display 34. The text indicating that there is a puddle near the door is, for example, “There is a puddle near your feet” or “Be careful of a puddle”. A summary image indicating that there is a puddle near the door is an image that simply represents a puddle near the door or the vehicle body, or an image that represents a foot stepping on a puddle, as shown in FIG. 7. The information presentation processor unit F10 may display both text indicating that there is a puddle and an icon image side by side in a display area corresponding to the driver's sight line direction. The information presentation processor unit F10 may display text such as “Caution” and an icon image indicating that there is a puddle near one's feet side by side. When step S105 is complete, this flow ends.

In step S106, the off-vehicle road surface monitor unit F61 analyzes the image acquired in step S103 to determine whether or not there is a recess such as a ditch at the hop-off spot. If there is a recess in the hop-off spot, an affirmative determination is made in step S106 and step S107 is performed. On the other hand, if there is no recess in the hop-off spot, a negative determination is made in step S106 and step S108 is performed.

In step S107, the information presentation processor unit F10 displays text or a summary image indicating that there is a recess near the door in the display area corresponding to the driver's sight line direction acquired in step S102. The text indicating that there is a recess near the door is, for example, “There is a recess near your feet” or “Be careful of the recess”. The outline image indicating that there is a recess near the door is an image that simply represents a recess near the door or the vehicle body, as shown in FIG. 8, or an image that represents a person losing their balance in the recess. The information presentation processor unit F10 may display text indicating that there is a recess and an icon image side by side in a display area corresponding to the driver's sight line direction. The information presentation processor unit F10 may display a text such as “Caution” and an icon image indicating that there is a recess underfoot side by side. When step S107 is complete, this flow ends.

In step S108, the off-vehicle road surface monitor unit F61 analyzes the image acquired in step S103 to determine whether there is a low-profile, three-dimensional object such as a large stone, step, block, brick or the like at the hop-off spot. If there is a three-dimensional object at the hop-off spot, an affirmative determination is made in step S108, and step S109 is performed. On the other hand, if there is no three-dimensional object at the hop-off spot, a negative determination is made in step S106 and step S110 is performed.

In step S109, the information presentation processor unit F10 displays text or a summary image indicating that there is a three-dimensional object near the door in the display area corresponding to the driver's sight line direction acquired in step S102. Examples of text indicating that there is a three-dimensional object near the door include “There is a three-dimensional object near your feet,” “Beware of three-dimensional object,” and the like. A summary image indicating that there is a three-dimensional object near the door is an image that simply depicts a three-dimensional object near the door or the vehicle body, or an image that depicts a person tripping over a three-dimensional object, as shown in FIG. 9. The information presentation processor unit F10 may display text indicating that a three-dimensional object is present and an icon image side by side in a display area corresponding to the driver's sight line direction. The information presentation processor unit F10 may display text such as “Caution” and an icon image indicating that there is a three-dimensional object underfoot side by side in a display area corresponding to the driver's sight line direction. When step S109 is complete, this flow ends.

In step S110, the outside-vehicle situation acquisition unit F6 determines whether it is safe to exit the vehicle based on the output signal of the surrounding monitor sensor 22. For example, it is determined whether there is another moving object scheduled to pass within a predetermined distance from the driver's seat side door. If another moving object scheduled to pass within a predetermined distance from the driver's seat side door is detected, it is determined that safety is low and step S111 is performed. On the other hand, if no other moving object that is scheduled to pass within a predetermined distance from the driver's seat side door is detected, step S112 is performed.

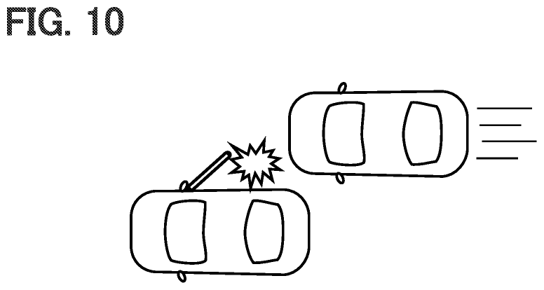

In step S111, as an approaching object attention-calling process, the information presentation processor unit F10 displays text or a summary image indicating that another moving object is scheduled to pass near the door in the display area corresponding to the driver's sight line acquired in step S102. The summary image showing that another moving object is scheduled to pass near the door is, for example, as shown in FIG. 10, a summary image showing another vehicle that is scheduled to pass by the own vehicle. Alternatively, text or a summary image proposing standby without opening the door is displayed. In addition, the information presentation processor unit F10 may display text or a summary image urging the driver to visually confirm the direction in which the approaching object exists.

Further, in step S111, the information presentation processor unit F10 may turn on the in-vehicle lighting device 39 installed on an inner panel of the driver's door (so-called door trim) in red. In addition, the information presentation processor unit F10 may output a predetermined notification sound from the in-vehicle speaker 35 in conjunction with the display of the text or summary image. When step S111 is complete, this flow ends.

In step S112, the information presentation processor unit F10 may display text or a summary image indicating that no collision risk object has been detected in the display area corresponding to the driver's sight line direction acquired in step S102 as a safety notification process. Alternatively, text or a summary image may be displayed that proposes checking the surroundings and opening the door. In step S112, the information presentation processor unit F10 may indicate that the safety confirmation has been complete by lighting up the in-vehicle lighting device 39 installed in the door trim in green. Note that step S112 is an optional element and may be omissible.

Note that when (i) a puddle is detected at the hop-off spot and (ii) it is registered in the driver data storage M2 that the driver dislikes getting his/her clothes dirty, the information presentation processor unit F10 may propose to move the vehicle to a place where there is no puddle and park the vehicle there. Additionally, if the schedule information indicates that the driver is not in a rush at the moment, meaning he or she has plenty of time, text may be displayed in a display area (a) provided at a predetermined position or (b) positioned in the direction of the driver's sight line, proposing move to a place where there is no puddle for parking the vehicle. A case where the schedule information indicates that an occupant has plenty of time is a case where there is no other schedule set within 30 minutes from the current time.

When a positive response is input from the driver in response to a parking position change proposal as described above, the HCU 1 may automatically move the vehicle to a different location in cooperation with the automatic parking ECU 27. Further, the automatic parking ECU 27 may re-park the vehicle to avoid a puddle by changing the direction of parking, such as changing from a head-on parking to a rear-end parking or vice versa.

<Example of Application to Hop-Off Situation (Part 2)>

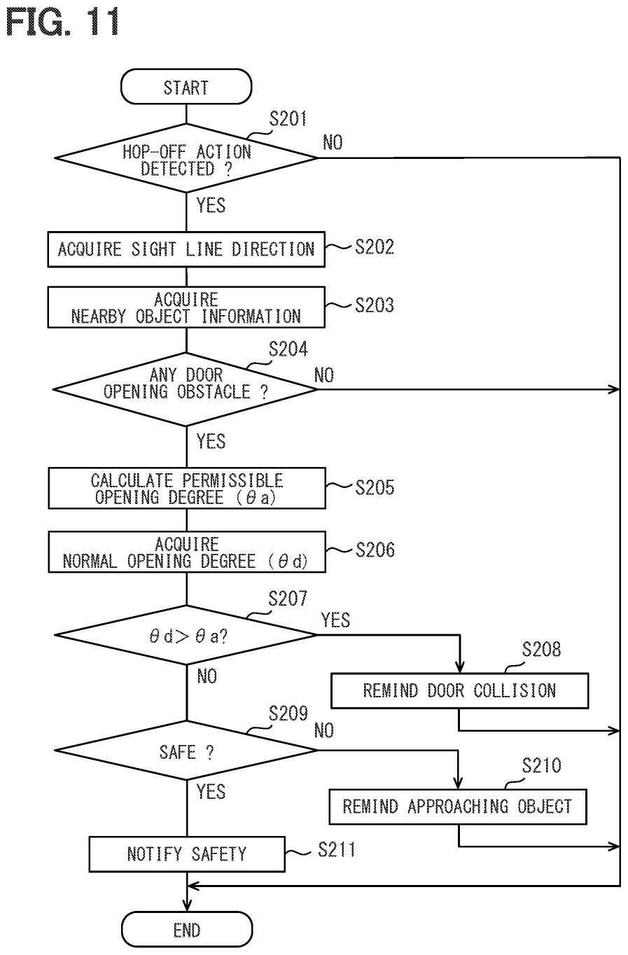

Here, using a flowchart shown in FIG. 11, another example of the operation of the HCU 1 in a situation where the driver parks and gets off from the vehicle will be explained. The series of processes shown in FIG. 11 may be performed as an alternative to the display control process at a time of getting off from a vehicle shown in FIG. 6, or may be performed in combination with/in parallel with the process shown in FIG. 6. The flowchart shown in FIG. 11 includes steps S201 to S211 as an example. The process shown in FIG. 11 is sequentially performed at a predetermined execution cycle, for example, while the travel speed of the own vehicle is lower than or equal to a predetermined threshold value. Note that this flow may be started using the detection of the driver's hop-off action by the hop-off action detection unit F2 as a trigger, and in that case, step S201 is omissible.

First, in step S201, the hop-off action detection unit F2 determines whether the driver has performed a hop-off action. If a hop-off action has not been detected, a negative determination is made in step S201, and this flow ends. On the other hand, if a hop-off action is detected, an affirmative determination is made in step S201 and the process shifts to step S202. In step S202, the sight line direction acquisition unit F1 acquires the driver's sight line direction, and the process shifts to step S203. In step S203, the outside-vehicle situation acquisition unit F6 acquires information on nearby objects existing around the own vehicle based on the output signal of the surrounding monitor sensor 22, and the process shifts to step S204.

In step S204, the door opening obstacle detection unit F62 determines whether or not there is a door opening obstacle based on the information acquired in step S203. If there is an obstacle to opening the door, the process shifts to step S205. On the other hand, if there is no obstacle to opening the door, this flow ends.

In step S205, a permissible opening degree, which is a degree up to which the driver's seat side door can be opened, is calculated based on a relative position of the door opening obstacle with respect to the driver's seat side door, and the process shifts to step S206. The permissible opening degree indicates a range in which the driver's seat side door can be opened without coming into contact with any door opening obstacles. The permissible opening degree can be calculated based on a concept such as an angle, for example. The permissible opening degree can be calculated, for example, as an opening degree of the driver's seat side door such that a distance between the door opening obstacle and the driver's seat side door is equal to or greater than a predetermined value (for example, 5 cm). θa in the drawing indicates the permissible opening degree.

In step S206, the information presentation processor unit F10 reads the normal opening degree stored in the driver data storage M2, and shifts to step S207. θd in the drawing indicates the normal opening degree. In step S207, the information presentation processor unit F10 compares the permissible opening degree calculated in step S205 and the normal opening degree read out in step S206. If the normal opening degree is greater than the permissible opening degree, step S208 is performed. On the other hand, if the normal opening is less than or equal to the permissible opening degree, step S209 is performed.

In step S208, the information presentation processor unit F10 displays text or a summary image indicating that there is a possibility of the door coming into contact with another vehicle or the like as a door collision attention calling in the display area corresponding to the direction of the driver's sight line acquired in step S202. For example, when the driver's sight line is directed toward the proximity of the shift lever, the above-described information is displayed on a display closest to the shift lever, such as the center display 32 or the like.

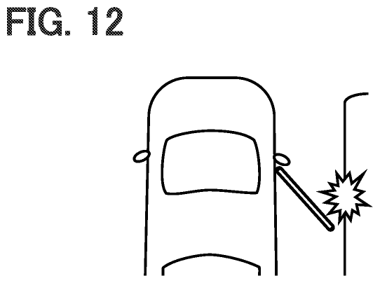

The summary image indicating that there is a possibility that the door will come into contact with another vehicle or the like is, for example, an image showing a state in which an opening door is in contact with another object, as shown in FIG. 12. Note that the information presentation processor unit F10 may display text urging the driver to open the door slowly in a display area in the direction of the driver's sight line as a door collision attention calling. The text that urges the user to open the door slowly is, for example, “Please open slowly (and carefully).” By presenting recommended actions (how to deal/dealing) rather than presenting the possibility of a collision, it is easy for the driver to recognize what he/she should do. According to a configuration in which dealing is presented as a door collision attention calling, convenience can be improved because the driver does not have to think about how to deal, compared to a case where the possibility of a door collision itself is presented. In addition, the driver can recognize the reason in the process of opening the door according to the dealing notified by the system.

The processing in steps S209 to S211 can be the same as steps S110 to S112, so a description thereof will be omitted.

In addition, when the driver opens the door of the driver's seat in a situation where there is an obstacle to opening the door, the distance between the door opening obstacle and the door may be notified by using (a) voice/sound or (b) attention-calling lighting color of the in-vehicle lighting device 39 that is installed on ab inside surface of the door of the driver's seat.

Further, if it is determined that the target parking position is in a narrow environment in a pre-parking stage, i.e., at a predetermined distance before the target parking position, the information presentation processor unit F10 may propose that the driver gets off from the vehicle at such point and use of the automatic parking function.

<Example of Application to Hop-Off Situation (Part 3)>

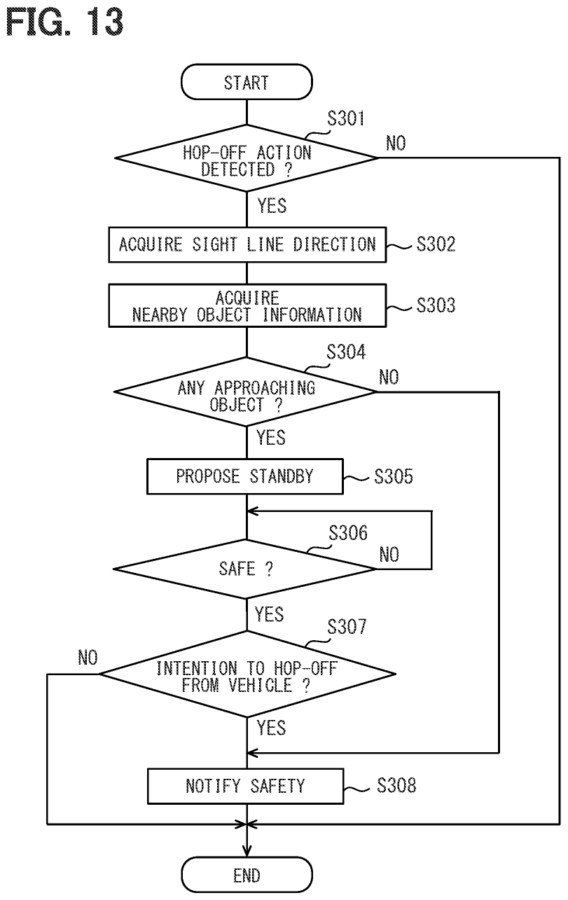

Here, using a flowchart shown in FIG. 13, another example of the operation of the HCU 1 in a situation where the driver parks and gets off from the vehicle will be explained. The series of processes shown in FIG. 13 may be performed as an alternative to the display control process at the time of getting off from a vehicle described above, or may be performed in combination with/in parallel with the processes already explained. The flowchart shown in FIG. 13 includes steps S301 to S308 as an example. The process shown in FIG. 13 is sequentially performed at a predetermined execution cycle, for example, while the travel speed of the own vehicle is lower than or equal to a predetermined threshold value. Note that this flow may be started using the detection of the driver's hop-off action by the hop-off action detection unit F2 as a trigger, and in that case, step S301 is omissible.

First, in step S301, the hop-off action detection unit F2 determines whether the driver has performed a hop-off action. If a hop-off action has not been detected, a negative determination is made in step S301, and this flow ends. On the other hand, if a hop-off action is detected, an affirmative determination is made in step S301 and the process shifts to step S302. In step S302, the sight line direction acquisition unit F1 acquires the driver's sight line direction, and the process shifts to step S303. In step S303, the outside-vehicle situation acquisition unit F6 acquires information on nearby objects existing around the own vehicle as the output signal of the surrounding monitor sensor 22, and the process shifts to step S304.

In step S304, the standby necessity determination unit F7 determines whether the situation is the door open standby recommended situation based on the information acquired in step S303. Specifically, it is determined whether there is an approaching object that is scheduled to pass by within a predetermined distance from the driver's seat side door. If there is an approaching object that satisfies the above-described condition, the process shifts to step S305. On the other hand, if there is no approaching object that satisfies the above-described condition, this flow ends.

In step S305, the information presentation processor unit F10 displays text or a summary image proposing standby without opening the door in the display area corresponding to the driver's sight line direction acquired in step S302. The process in step S305 is configurable to be similar to step S111. That is, in addition to displaying an image proposing standby without opening the door, the information presentation processor unit F10 may also turn on the in-vehicle lighting device 39 installed in the door trim of the driver's seat in red. In addition, the information presentation processor unit F10 may output a predetermined notification sound from the in-vehicle speaker 35 in conjunction with the display of the above-described image. The display content in step S305 may be text or a summary image indicating the reason why standby without opening the door is recommended.

In step S306, the outside-vehicle situation acquisition unit F6 determines whether or not it is possible to safely get off from the vehicle based on the output signal of the surrounding monitor sensor 22, or more specifically, the outside-vehicle situation acquisition unit F6 determines whether or not an approaching object that is scheduled to pass by the driver's seat side door remains. The above-described determination corresponds to a process of determining whether it is no longer necessary to standby without opening the door. If there are no approaching objects scheduled to pass by the door, an affirmative determination is made in step S306 and the process shifts to step S307. On the other hand, if there is an approaching object scheduled to pass by the door, step S306 is performed periodically (for example, in a cycle of one second).

In step S307, the hop-off action detection unit F2 determines whether the driver still has an intention of hop-off, i.e., getting out of the vehicle, based on images from the in-vehicle sensor 21 and the in-vehicle camera 23. For example, if it is detected that the driver is placing his hand on the inner door handle or looking at the outside of the door, it is determined that the driver still intends to get off from the vehicle, and the process shifts to step S308. On the other hand, if the driver does not have an intention of getting off from the vehicle anymore, the various displays and the lighting of the in-vehicle lighting device 39 are terminated, and then this flow ends. For example, if the driver is performing any action other than preparing to get off from the vehicle, such as operating a smartphone or the like, it is determined that the driver no longer intends to get off from the vehicle. Note that, in such case, this flow may be periodically performed in case that the driver attempts to get off from the vehicle again.

In step S308, similar to step S112, a process is performed to notify that it is possible to get off from the vehicle safely or that the reason for standby has been resolved. Note that step S308 is an optional element and is omissible. That is, the information presentation processor unit F10 may express that the safety confirmation has been complete by switching the lighting color of the in-vehicle lighting device 39 installed in the door trim of the driver's seat side door from red to green. Further, the display content in step S308 may be text or a summary image indicating that the reason for standby has disappeared or that the door may be opened.

In the above, the case where there is an approaching object has been described as the door open standby recommended situation, but the situation is not limited thereto. The HCU 1 may similarly execute the processes from step S305 onwards when a person is about to get out of the parallel parked vehicle, or more specifically, when the door of the passenger seat of the parallel parked vehicle is moving. When a person is about to get into the parallel parked vehicle from the passenger seat side, that is, when there is a person between the own vehicle and the parallel parked vehicle, the standby proposal may similarly be performed.

<Example of Application to Hop-Off Situation (Part 4)>

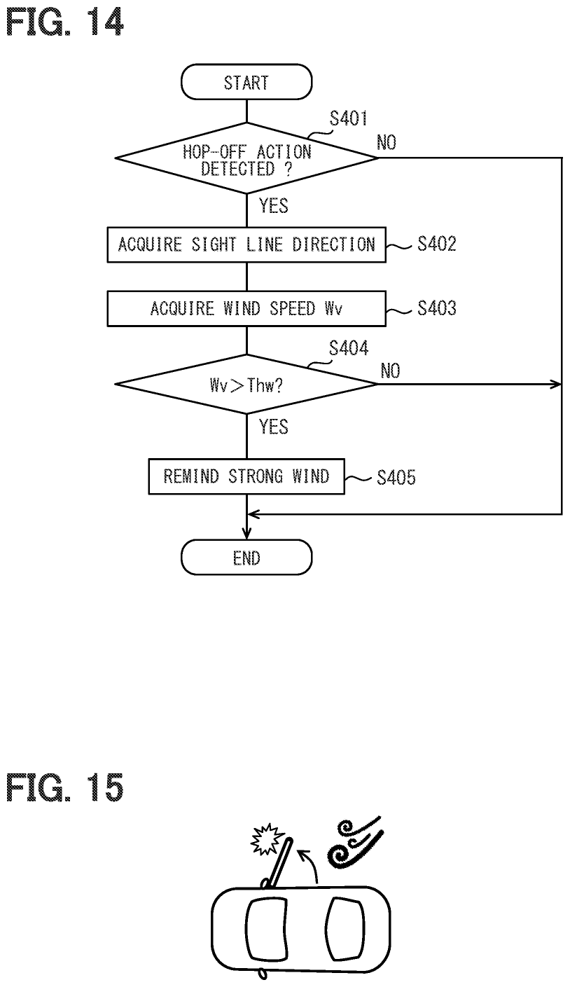

Here, using a flowchart shown in FIG. 14, another example of the operation of the HCU 1 in a situation where the driver parks the vehicle and gets off from the vehicle will be explained. The series of processes shown in FIG. 14 may be performed as an alternative to the display control process at the time of getting off from the vehicle described above, or may be performed in combination with/in parallel with the processes already explained. The flowchart shown in FIG. 14 includes steps S401 to S405 as an example. The process shown in FIG. 14 is sequentially performed at a predetermined execution cycle, for example, while the travel speed of the own vehicle is lower than or equal to a predetermined threshold value. Note that this flow may be started using the detection of the driver's hop-off action by the hop-off action detection unit F2 as a trigger, and in that case, step S401 is omissible.

First, in step S401, the hop-off action detection unit F2 determines whether the driver has performed a hop-off action. If a hop-off action has not been detected, a negative determination is made in step S401, and this flow ends. On the other hand, if a hop-off action is detected, an affirmative determination is made in step S401 and the process shifts to step S402. In step S402, the sight line direction acquisition unit F1 acquires the driver's sight line direction, and the process shifts to step S403. In step S403, the wind force acquisition unit F3 acquires wind speed information, for example, by communicating with an external server, and the process shifts to step S404. Wv in the drawing indicates a wind speed. The level of the wind speed may also be identified by analyzing the electric signal output from the out-vehicle microphone 24.

In step S404, the outside-vehicle situation acquisition unit F6 determines whether the wind speed acquired in step S403 exceeds a predetermined strong wind threshold value. Thw in the drawing indicates the strong wind threshold value. The strong wind threshold value can be set to, for example, 6.0 m/sec, 8.0 m/sec, 10.0 m/sec or the like. This step corresponds to processing for determining whether or not the outside of the vehicle falls under a strong wind condition. If the acquired wind speed exceeds the strong wind threshold value, the process shifts to step S405. On the other hand, if the acquired wind speed does not exceed the strong wind threshold value, this flow ends.

In step S405, the information presentation processor unit F10 displays text or a summary image indicating that the door may open forcefully due to strong winds as a strong wind attention calling in the display area corresponding to the driver's sight line direction acquired in step S402. The summary image indicating that there is a possibility that the door may open forcefully due to strong winds is, for example, an image schematically showing the wind and the opened door, as shown in FIG. 15. Note that the information presentation processor unit F10 may display text instructing the driver to open the door slowly or by firmly gripping it in the display area in the driver's sight line direction as a door collision attention calling. The text that prompts the user to open the door carefully may be something like “Hold firmly to open the door.” By presenting how to deal with the situation rather than showing the possibility of a collision, the driver can easily recognize what to do. When the process in step S405 is complete, this flow ends.

After performing the information presentation process in step S405, the HCU 1 may warn the driver to grip the inner door handle more strongly if the driver's grip on the inner door handle is weak. The force with which the driver grips the inner door handle may be determined by analyzing images captured by the in-vehicle camera 23, or the inner door handle may be provided with a sensor for detecting a grip force. If the driver is a person with weak muscles, such as an elderly person, a mode of notification may be made intensified. Further, when the present disclosure is applied to a rear seat, and the like, and the occupant seated in the target seat is a child or an elderly person, in step S405, the process may propose the driver to open and close the door for the target seat.

<Example of Application to Parking Scene in a Facility Parking Lot>

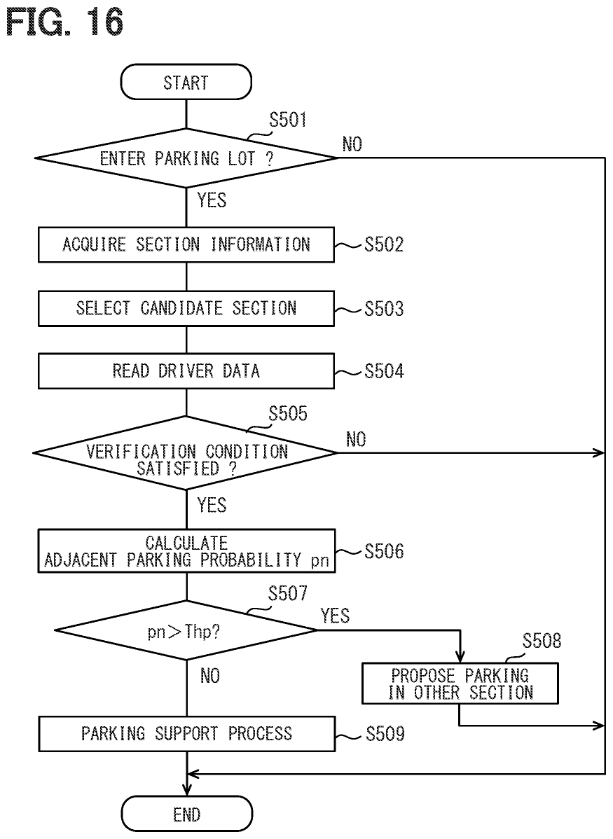

Here, using a flowchart shown in FIG. 16, another example of the operation of the HCU 1 in a situation where the driver parks the vehicle in any one of a plurality of parking sections provided in the facility-side parking lot will be explained. The series of processes shown in FIG. 16 can be performed in combination with/in parallel with the display control process at the time of getting off from the vehicle described above. The flowchart shown in FIG. 16 includes steps S501 to S509 as an example. The process shown in FIG. 16 is performed sequentially at a predetermined execution cycle. Note that this flow may be started using the detection of entry of the own vehicle into the facility-side parking lot by the park entry detection unit F8 as a trigger, and in such case, step S501 is omissible.

In step S501, the park entry detection unit F8 determines whether or not the vehicle has entered a facility-side parking lot based on a signal from the navigation ECU 28. If the signal indicating that the vehicle has entered the facility-side parking lot is not input, a negative determination is made in step S501 and the flow ends. On the other hand, if a signal indicating that the vehicle has entered the facility-side parking lot is input from the navigation ECU 28, an affirmative determination is made in step S501, and step S502 is performed. Note that, as described above, the park entry detection unit F8 may perform the determination of entering the facility-side parking lot using various methods.

In step S502, the candidate section acquisition unit F41 acquires the position information of the parking section provided in the parking lot based on the detection result of the surrounding monitor sensor 22 or the distribution data from the parking lot device, and the process shifts to step S502. In step S503, a candidate section is automatically selected from among the parking sections acquired in step S502 according to a preset rule (i.e., algorithm), and the process shifts to step S504. Note that the candidate section may be manually selected based on the driver's operation, as described above.

In step S504, the park position acquisition unit F4 refers to the driver data storage M2 and acquires information such as the driver's level of driving skill, preferences, and the like, and the process shifts to step S505. In step S505, it is determined whether a predetermined verification condition is satisfied based on the driver information acquired in step S504. The verification condition here is a condition for verifying whether the candidate section is a section where there is a high possibility that another vehicle will be parked in the adjacent section on the driver's seat side. If another vehicle is parked in a section adjacent to the driver's seat, it may be difficult to open or close the door depending on the size of the parking section. In one aspect, the verification condition can also be interpreted as a condition for verifying whether the selected candidate section is a section in which the door can be easily opened and closed.

For example, the park position acquisition unit F4 determines that the verification condition is satisfied when the driver's driving skill is in a low level. Alternatively, it may be determined that the verification condition is satisfied if there is a possibility that the door will protrude from a parking frame when the door is opened at the driver's normal opening degree. In addition, if the driver data, which may be registered either automatically or manually, indicates that the driver does not like another vehicle to be parked in the section adjacent to the driver's seat, it is determined that the verification condition is satisfied.

As a result of the determination in step S505, if the verification condition is satisfied, step S506 is performed. On the other hand, if the verification condition is not satisfied, this flow ends. Therefore, for example, if the driver's driving skill is equal to or higher than a predetermined threshold value, a parking position change proposal described in the subsequent process will not be performed.

In step S506, the adjacent parking probability acquisition unit F9 calculates the adjacent parking probability based on the use probability data for each section acquired from the parking lot device by wireless communication or the parking history data of the own vehicle in the relevant section, and the process shifts to step S507. In the drawing, pn indicates an adjacent parking probability. Note that the adjacent parking probability used in subsequent processing is preferably a probability that an adjacent vehicle exists on the driver's seat side at the time of exiting the parking lot. The adjacent parking probability acquisition unit F9 may roughly estimate a time slot for exiting the parking lot based on the driver's schedule information and a past visit history of the facility, and may calculate the adjacent parking probability of an estimated exit time slot. The future adjacent parking probability may be calculated from the use probability data for each time slot distributed from the parking lot device.

In step S507, it is determined whether the adjacent parking probability (pn) exceeds a predetermined probability threshold value (Thp). If the adjacent parking probability exceeds the probability threshold value, step S508 is performed. On the other hand, if the adjacent parking probability is less than or equal to the probability threshold value, step S509 is performed. The probability threshold value may be set to 50%, for example.

In step S508, the information presentation processor unit F10 displays text or a summary image proposing parking in another section where the adjacent parking probability is lower than the present one. A section with a lower adjacent parking probability mainly corresponds to a section far from the entrance/exit of the facility. The information is displayed in a display area existing in the user's sight line direction. If an operation to change the section in which the own vehicle is parked is received from the driver, processing for setting another section as the target parking position is started. If the adjacent parking probability value is high, by proposing a change of the parking position, an effect of eliminating the anxiety of being cramped when exiting from the relevant parking section.

In step S509, the HCU 1 performs a parking support process in cooperation with the automatic parking ECU 27. The content of the parking support process may be designed as appropriate. For example, while the automatic parking ECU 27 automatically performs steering, acceleration and deceleration may be left to the driver's disposal. As the parking support process, the HCU 1 displays, on the center display 32 or the like, (a) an image showing a positional relationship between the parking position and the own vehicle or (b) a bird's-eye view image made by combining images from surrounding monitoring cameras. The bird's-eye view image is an image looking down on the own vehicle and its surrounding area from above. A composite image displayed as the parking support process may be a composite image that shows a road surface in a traveling direction of the own vehicle through a translucent portion of the vehicle body made in the image.

<Example of Application to Starting Situation>

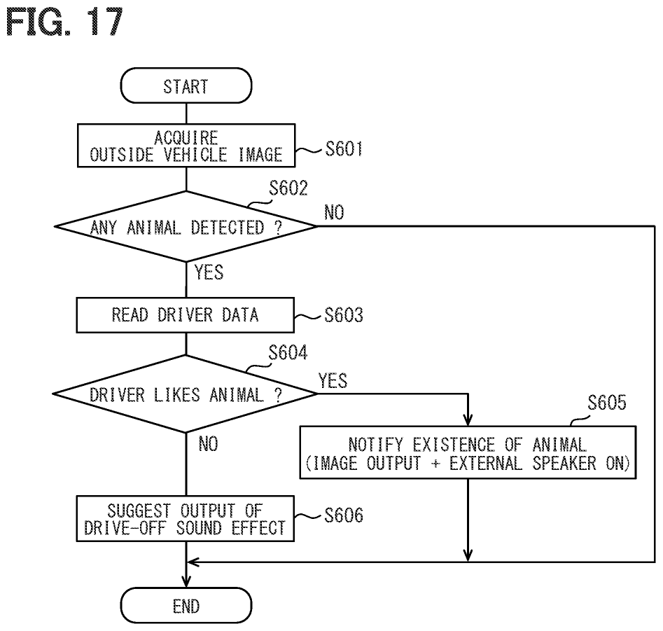

Here, using a flowchart shown in FIG. 17, an example of the operation of the HCU 1 in a situation where a driver gets on the vehicle will be described. The flowchart shown in FIG. 17 includes steps S601 to S606 as an example. The process shown in FIG. 17 is performed based on the fact that the driving electric power is turned on. In addition, this flow may be started using the fact that a seat belt is fastened or the driver's door is opened in a parked state as a trigger.

First, in step S601, the outside-vehicle situation acquisition unit F6 acquires current image data of the outside of the vehicle from the surrounding monitoring camera that has been activated when the driving electric power is turned on, and the process shifts to step S602. In step S602, the pre-start surrounding confirmation unit F63 analyzes the image data acquired in step S601 to detect animals existing in a nearby area of the own vehicle. For example, the pre-start surrounding confirmation unit F63 detects an animal such as a cat existing in the nearby area by comparing an image outside the vehicle compartment taken by a surrounding monitoring camera when the vehicle is parked with an image outside the vehicle compartment acquired in step S601. The animals to be detected may include cats, dogs, birds such as pigeons and chickens, rabbits, raccoon dogs, and the like. It is assumed that, when the vehicle is parked, the HCU 1 is configured to store image data from the surrounding monitoring camera at that time in the storage 13 as comparison data.

If no animal is detected in the nearby area, a negative determination is made in step S602 and the flow ends. On the other hand, if an animal is detected in the nearby area, step S603 is performed. In step S603, the information presentation processor unit F10 refers to the driver data stored in the driver data storage M2, and shifts to step S604.

In step S604, the information presentation processor unit F10 determines whether the driver likes animals in general or the animal detected in step S602, based on the driver data read out in step S603. If the driver likes animals, or if the driver likes the animal detected in step S602, step S605 is performed. On the other hand, if the driver does not like animals or does not like the animal detected in step S602, step S606 is performed.

In step S605, the information presentation processor unit F10 displays text or a summary image indicating that an animal exists. The information may preferably be displayed in a display area in the user's sight line direction, but may be displayed in a predetermined display device. Further, the information presentation processor unit F10 may display, on the center display 32, an image of a surrounding monitoring camera capturing an animal. Further, the HCU 1 may drive the external speaker 36 so that the driver can call out to the animal.

In step S606, the information presentation processor unit F10 displays text or a summary image proposing that a predetermined drive-off sound effect be outputted from the external speaker 36 in a display area in the user's sight line direction. The drive-off sound effect is a sound effect prepared in advance for driving off an animal existing near the vehicle, and can be, for example, a sound at a frequency that animals are not good at, or an ultrasonic wave.

The above configuration corresponds to a configuration in which the content of the proposal is changed according to whether the detected animal corresponds to the animal preferred by the driver. Although the case where an animal is detected has been exemplified in the above, the detection target may also be a pedestrian including a child. When a pedestrian is detected near the vehicle, the HCU 1 may propose turning on the external speaker 36. According to such configuration, the driver himself can use the external speaker 36 to warn the pedestrian.

<About the Effects of the Above Embodiment>

The above-described configuration is created by focusing on the following new problems. That is, in general, while the vehicle is traveling, the driver's sight line is directed toward the front of the vehicle. On the other hand, after the vehicle is parked, the direction of the driver's sight line varies from direction to direction, such as to the outside of the door or near the shift lever. In other words, the driver is not necessarily facing forward. In a configuration in which a summary of notification targets and recommended actions (hereinafter referred to as “summary, and the like”) are presented on the meter display 31 or the like when the driver is not facing forward, it is difficult for the driver to recognize the information.

To address such problems, the above-described configuration displays an image or text indicating a summary of a notification event or a recommended action in a display area corresponding to the direction of the driver's sight line. For example, when the driver is directing his or her sight line/face toward the door of the driver's seat, a summary image or the like corresponding to the notification event is displayed on the door display 34. According to such configuration, it is possible to increase the recognizability of the driver regarding the summary of the notification target.

In addition, as a comparison configuration, a simple icon image that does not include information such as recommended actions or specific warning reasons, that is, an attention-calling image shown in FIG. 5, may be displayed at a position in the user's sight line direction or in a display arranged in the direction where the attention target is existing. However, in such a comparison configuration, even if the driver can understand that an attention is being called for something, it is difficult to intuitively understand the specific reason and the action (how to deal with the situation) to be taken.

To address such problems, according to the configuration of the present disclosure, text or a summary image indicating the content or how the problem should be dealt with regarding the notification target event is displayed in the user's sight line direction. Therefore, it is easy for the driver to intuitively recognize the actions he or she should take and the reasons for them. Further, the HCU 1 of the present disclosure autonomously determines and displays information to be presented to the driver according to the detection target and situation. Therefore, it becomes possible to present information appropriate to the situation to the driver in an easy-to-understand manner.

Further, as a preferred embodiment, the HCU 1 of the present disclosure takes into consideration the driver's personality, schedule, driving skills, and the like, and then makes proposal such as changing the parking position. According to the configuration of the present disclosure, it is possible to further improve convenience for the driver, compared to a configuration in which a uniform proposal is made regardless of the driver.

In addition, as a display provided at a position on the door side when viewed from the driver, a display provided in a side mirror is assumed. However, because the display screen installed in the side mirror is small, it is difficult to display text or complex summary images. On the other hand, according to the configuration provided with the door display 34 having a relatively large display area as disclosed in the present application, it is possible to present a variety of information to the driver who is looking toward the door.

While one embodiment of the present disclosure has been described above, the present disclosure is not limited to the embodiment described above, and various modifications to be described below are included in the technical scope of the present disclosure, and the present disclosure may further be implemented as various modifications within the scope not departing from the spirit of the present disclosure, in addition to the modifications to be described below. For example, various supplements and/or modifications to be described below can be implemented in combination as appropriate within a scope that does not cause technical inconsistency. The members having the same functions as described above are denoted by the same reference numerals, and the description of the same members may be omitted. Further, when only a part of the configuration is mentioned, the above description is applicable to the rest of such configuration.

<Other Operation Examples of HCU 1 (Part 1)>

The HCU 1 may switch a locked state of the door to an unlocked state based on an entry of the own vehicle into a specific unlocked area, such as an entrance of a hotel, restaurant, company, or office building.

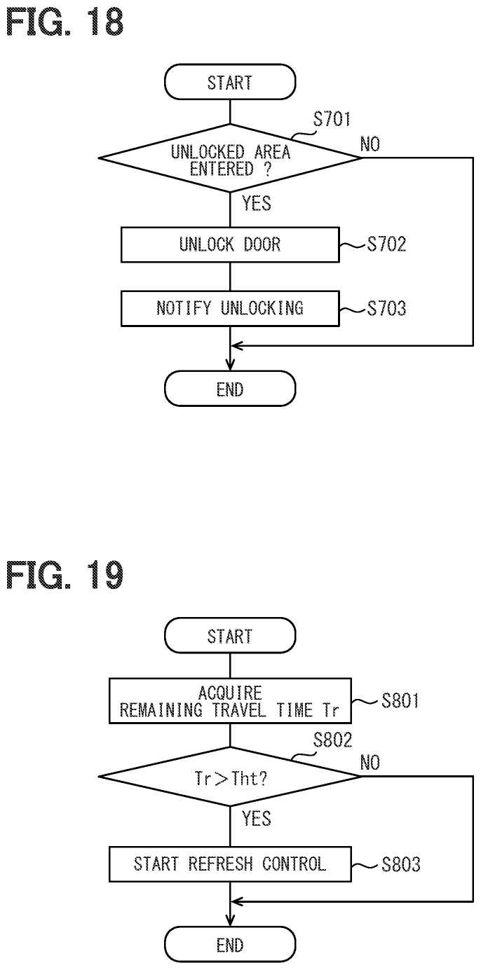

For example, the HCU 1 determines whether the vehicle has entered the unlocked area based on the output signal of the navigation ECU 28 (Step S701 in FIG. 18). The unlocked area may be registered in advance in the HCU 1 as the driver data by the driver's operation, or may be automatically registered based on the past visit history. For example, the driver data management unit F5 may communicate with a predetermined server to acquire information on a hotel reserved by the driver and may register the entrance of such hotel as an unlocked area. Further, the entrance of an office where the driver works may be registered as the unlocked area. The unlocked area may be an area where the driver has consented to switch the door from the locked state to the unlocked state. Determining whether or not the vehicle has entered an unlocked area can be done using a variety of methods, such as comparing position information with map data or detecting a specific signboard through image recognition, similarly to determining whether or not the vehicle has entered the facility-side parking lot.

The HCU 1 switches the door to an unlocked state based on the fact that the own vehicle has entered the unlocked area (step S702). Changing the locked state of the door may be performed in cooperation with a body ECU. For example, the HCU 1 may cause the body ECU to drive a door lock motor by outputting an unlock request signal to the body ECU. When unlocking the door is complete, the HCU 1 displays text or a summary image indicating that the door has been switched to the unlocked state on the center display 32, HUD 33, or the like (step S703).

In addition, although a mode in which the door is unlocked and the driver is subsequently notified of the fact has been described in the above, the present disclosure is not limited thereto. The HCU 1 may simply propose switching the door to the unlocked state based on the fact that the own vehicle has entered the unlocked area. Moreover, although the configuration has been described in the above in which automatic unlocking or an unlocking proposal is performed based on the fact that the own vehicle has entered a predetermined unlocked area, the present disclosure is not limited thereto. For example, the HCU 1 may automatically unlock or make an unlock proposal based on detecting a person wearing a specific badge or uniform by analyzing images from a surrounding monitoring camera. In an assumption, a person wearing a specific badge or uniform includes a hotel doormen, an office security guards and the like.

<Other Operation Examples of HCU 1 (Part 2)>

The HCU 1 may be configured to perform control to refresh the driver's body in accordance with the arrival time at a destination so that the driver can move his body smoothly after arriving at the destination. Generally, there is little physical activity in a vehicle during a travel, thereby the longer the driving time, the more fatigued the driver's body becomes. The refresh control is a control that deals with the fatigue caused by the above-mentioned driving. The refresh control is mainly performed in cooperation with the air conditioner 38.

For example, the HCU 1 acquires a remaining travel time, which is the remaining time until arriving at the destination, from the navigation ECU 28 (FIG. 19, step S801). Tr in the drawing indicates the remaining travel time. Then, based on the fact that the remaining travel time has become shorter than a predetermined refresh start threshold value (step S802 YES), the HCU 1 causes the air conditioner 38 to start refresh control (step S803). Tht in the drawing is a refresh start threshold value. The refresh start threshold value may be set to, for example, 10 minutes or 15 minutes. The refresh control includes, for example, outputting scents such as mint, lemon, and the like, driving seat massage device, and adjusting an air conditioning temperature. The above refresh control may be applied only when the total travel time by the vehicle is equal to or greater than a predetermined threshold value (for example, 3 hours).

Further, if the driver is in poor health and temperature outside the vehicle is low, there is a high possibility that economy syndrome (pulmonary thromboembolism, pulmonary embolism) will occur when getting off from the vehicle. In response to such concerns, the HCU 1 may gradually bring a target temperature of the air conditioner 38 closer to the outside temperature as refresh control.

<About Display Area Variations>

The display areas selectable by the HCU 1 are not limited to the above-described combinations. When a room mirror (i.e., a rearview mirror) is configured as an electronic mirror using a display device, the room mirror can also be included in the display area that is selectable by the HCU 1 as a destination for information display. The same applies to side mirrors. The combinations of display areas that can be selected by the HCU 1 and their specific positions are changeable as appropriate.

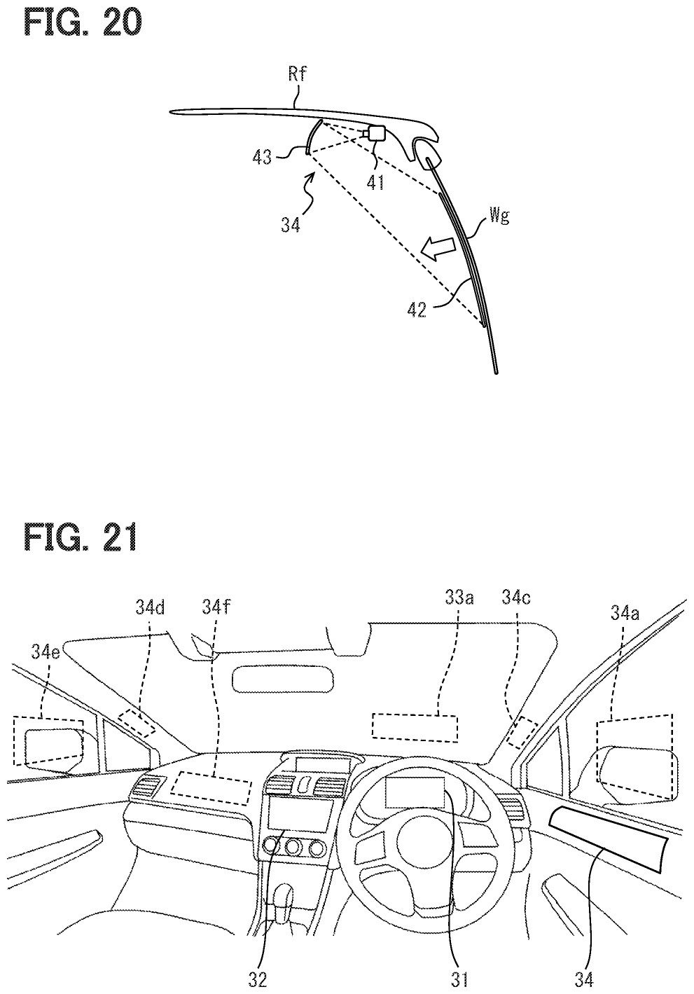

Further, the door display 34 may be a device that displays an image on a window glass Wg adjacent to the driver's seat by irradiating an image light onto the window glass Wg. For example, the door display 34 may be realized using a projector 41 for emitting an image light and a screen 42, as shown in FIG. 20, for example. The screen 42 is a transparent film for reflecting the image light toward the interior of the vehicle, and is attached to a surface of the window glass Wg on an interior side of the vehicle, which is an irradiation target of the image light. The screen 42 and the window glass Wg may be integrated. A mirror 43 for magnifying and reflecting the image light emitted from the projector 41 toward the screen 42 may be interposed between the projector 41 and the screen 42. The mirror 43 is preferably a concave mirror. The mirror 43 may also be a plane mirror. The projector 41 and the mirror 43 are arranged on a surface of a roof portion Rf on a vehicle compartment side, that is, on the ceiling portion of the vehicle compartment.

The numeral 34a in FIG. 21 indicates a display area by the projector 41. The display area 34a formed on a side window of the door also corresponds to the door display area. The projector 41 may be configured to project the image light onto an area within a predetermined distance from the lower end of the window frame in the door trim of the door of the driver's seat. Even with such a configuration, an image can be displayed at a position corresponding to the driver's sight line direction, such as an upper panel of the door trim or an armrest. The projector 41 and the mirror 43 may be configured to be capable of dynamically change their posture with respect to the vehicle using an actuator such as a motor so that they can project an image to an arbitrary position within the vehicle compartment. In such case, the display area (projection area) of the projector 41 may be controlled by the HCU 1.

Further, the HCU 1 may be configured to use the projector 41, to display a summary image on various positions, such as an A-pillar on the driver's seat side, the A-pillar on the navigator's seat side, an area of the instrument panel in front of the passenger seat, the door on the navigator's seat side, and the like, as shown in FIG. 21 and the like A numeral 34c shown in FIG. 21 indicates a display area of the A-pillar on the driver's seat side by the projector 41. A numeral 34d indicates a display area of the A-pillar on the passenger seat side by the projector 41. A numeral 34e indicates a display area arranged on the navigator door. A numeral 34f indicates a display area formed in the area of the instrument panel in front of the passenger seat. The plurality of display areas may be realized by dynamically adjusting the posture of the projector 41 using a motor or the like. A plurality of projectors 41 may be arranged on the ceiling portion of the vehicle compartment so that a plurality of display areas can be formed. Part or all of the display areas 34c to 34e may be realized using a transmissive skin display or the like instead of the projector 41.

<About Applicable Vehicle Variations>

The present disclosure is applicable to a variety of vehicles travelable on the road. The present disclosure is installable on various vehicles capable of traveling on the road, such as four-wheeled vehicles, trucks, and trailers. The vehicle to which the system or device or method or the like according to the present disclosure is applied may be an owner vehicle owned by an individual, or a service car. The service car refers to, for example, a vehicle provided for a car-sharing service or a vehicle rental service. The present disclosure may be applied to robot taxis, unmanned buses, and the like that do not have a driver on board.

<About Application to Passenger Seats, and the Like>

As described at the beginning, part or all of the present disclosure can be implemented as an information presentation device for an occupant seated in a seat other than the driver's seat, such as a passenger seat. In other words, the predetermined seat is not limited to the driver's seat, but may be a passenger seat or a rear seat. The rear seats can be divided into a right rear seat and a left rear seat. The door adjacent to the passenger seat refers to the door of the passenger seat. The door adjacent to the right rear seat refers to the door of the right rear seat provided in the vehicle. A door adjacent to a certain seat is a door of the certain seat and can be understood as a door closest to the certain seat.

### FIRST ADDITIONAL NOTE

The device, the system, and the method described in the present disclosure may be performed by a dedicated computer constituting a processor that is programmed to execute one or more functions performed by a computer program. The device and the method described in the present disclosure may be performed using a dedicated hardware logic circuit. Further, the device and the method described in the present disclosure may be performed by one or more dedicated computers configured by a combination of a processor that executes a computer program and one or more hardware logic circuits. For example, some or all of the functions included in the HCU 1 may be performed as hardware. A configuration in which a certain function is performed by hardware includes a configuration in which the function is performed by use of one or more ICs or the like. As a processor (arithmetic core), a CPU, an MPU, a GPU, a DFP (Data Flow Processor), or the like is adoptable. Further, some or all of the functions included in the HCU 1 may be realized by combining multiple types of arithmetic processing devices. Some or all of the functions included in the HCU 1 may be realized using a system-on-chip (SoC), FPGA, ASIC, or the like. The FPGA is an abbreviation for Field Programmable Gate Array. The ASIC is an abbreviation of Application Specific Integrated Circuit.

Further, the computer program may be stored in a computer-readable non-transitionary tangible storage medium as an instruction performed by the computer. As a program storage medium, Hard-disk Drive (HDD), Solid State Drive (SSD), flash memory, and Secure Digital (SD) card is adoptable, for example.

The scope of the present disclosure includes, for example, a program for causing a computer to function as the HCU 1, a non-transitional physical recording medium such as a semiconductor memory in which this program is recorded, a system having the HCU 1 as a component, and the like.

What is claimed is:

1. An information presentation device configured to select at least one area from among a plurality of display areas where information is to be displayed to an occupant of a predetermined seat provided in a vehicle, the plurality of display areas including at least a door display area on a door adjacent to the seat, the information presentation device comprising:
a display processing unit configured to display, in at least one of the plurality of display areas, information related to a situation outside the vehicle;
a sight line direction acquisition unit configured to acquire information indicating a sight line direction of the occupant;
a hop-off action detection unit configured to detect a hop-off action of the occupant;
an off-vehicle road surface monitor unit configured to determine whether a predetermined notification target event exists in a hop-off spot, which is an area of a road surface within a predetermined distance from the door, based on an image of a camera that is configured to capture an outside of the vehicle; and
a schedule storage configured to store schedule information of the occupant, wherein
the display processing unit is configured to
change, according to the sight line direction of the occupant, a display position of information related to the situation outside the vehicle,
determine, when the off-vehicle road surface monitor unit determines that the notification target event exists in the hop-off spot, whether the occupant has time to spare based on the schedule information, and
when the off-vehicle road surface monitor unit determines that the notification target event exists in the hop-off spot,
display, in a display area positioned in the sight line direction of the occupant, text or an image proposing to change a parking position, when determining that the occupant has time to spare, or
display, in the display area, text or an image indicating a content of the notification target event, when not determining that the occupant has time to spare.

2. The information presentation device according to claim 1, wherein
the display processing unit is configured to, when the sight line direction of the occupant is toward a place where the door is positioned, display information related to the situation outside the vehicle in the door display area.

3. The information presentation device according to claim 1, further comprising:
an outside-vehicle situation acquisition unit configured to acquire information indicating at least one of (a) a behavior of another moving object and (b) a road surface condition in a proximity of the vehicle, based on an output signal of a surrounding monitor sensor mounted on the vehicle, wherein
the outside-vehicle situation acquisition unit is configured to, based on the acquired information, detect a predetermined notification target event outside the vehicle, and
the display processing unit is configured to, in the display area positioned in the sight line direction of the occupant, display text or an image indicating (a) a content of the notification target event detected by the outside-vehicle situation acquisition unit or (b) how to deal with the notification target event.

4. The information presentation device according to claim 1, further comprising:
a door opening obstacle detection unit configured to determine whether a three-dimensional object, which possibly comes into contact with an opened door, exists within a predetermined distance from the door, based on an output signal from a surrounding monitor sensor mounted on the vehicle, wherein
the display processing unit is configured to display, in the display area positioned in the sight line direction of the occupant, text or an image indicating a possibility that the door possibly comes into contact with the three-dimensional object, based on detection of presence of the three-dimensional object.

5. The information presentation device according to claim 4, further comprising:
a normal door opening degree storage configured to store a normal door opening degree indicating a degree of opening of the door by the occupant on a daily basis, wherein
the display processing unit is configured to
acquire a permissible opening degree that is an opening degree of the door in a range in which the door can be opened without coming into contact with the three-dimensional object, based on the output signal of the surrounding monitor sensor, and
display, in the display area positioned in the sight line direction of the occupant, text or an image indicating that the door possibly comes into contact with the three-dimensional object, when the normal door opening degree is greater than the permissible opening degree.

6. The information presentation device according to claim 4, wherein
the information presentation device is for a vehicle configured to perform automatic parking and further comprising:
a parking position acquisition unit configured to acquire a target parking position, wherein
the door opening obstacle detection unit is configured to determine whether the three-dimensional object, which possibly comes into contact with the door when the door is opened, exists around the target parking position, based on the output signal of the surrounding monitor sensor, and
the display processing unit is configured to, when the door opening obstacle detection unit determines that the three-dimensional object exists before the target parking position, display, in the display area positioned in the sight line direction of the occupant, text or an image that proposes an occupant to hop off from the vehicle and to perform the automatic parking, before the vehicle reaches the target parking position.

7. The information presentation device according to claim 1, further comprising:
a park entry detection unit configured to detect that the vehicle has entered a parallel parking lot, which is a parking lot with a plurality of sections for parking a plurality of vehicles in parallel;
a candidate section acquisition unit configured to acquire, as a candidate section, a section in which the vehicle attempts to park in the parallel parking lot; and
an adjacent parking probability acquisition unit configured to acquire an adjacent parking probability based on (a) data wirelessly distributed from an equipment provided in the parallel parking lot or (b) parking history data of the vehicle in the candidate section, the adjacent parking probability indicating a probability that another vehicle parks in an adjacent section, which is a section adjacent to the candidate section in a seat side direction, which is one of a left side or a right side of the vehicle on which the predetermined seat is provided, wherein
the display processing unit is configured to propose parking in another section when the adjacent parking probability is greater than or equal to a predetermined probability threshold value.

8. The information presentation device according to claim 7, further comprising:
a proficiency level storage configured to store information indicating a level of driving skill of the occupant, wherein
the display processing unit is configured not to make a proposal according to the adjacent parking probability, when the level of the driving skill stored in the proficiency storage is equal to or higher than a predetermined threshold value.

9. The information presentation device according to claim 1, further comprising:
a pre-start surrounding confirmation unit configured to detect an animal or a pedestrian existing in a nearby area of the vehicle based on an output signal of a surrounding monitor sensor that is activated based on a turning on of a driving electric power of the vehicle, wherein
the display processing unit is configured to present, in the display area positioned in the sight line direction of the occupant, text or an image proposing to activate an external speaker, when the pre-start surrounding confirmation unit detects an animal or a pedestrian in the nearby area.

10. The information presentation device according to claim 9, further comprising:
a favorite animal storage configured to store information on a favorite animal of the occupant, wherein
when the pre-start surrounding confirmation unit detects the animal in the nearby area, the display processing unit is configured to change a content of proposal according to whether the detected animal corresponds to the favorite animal of the occupant.

11. The information presentation device according to claim 1, further comprising:
an outside-vehicle situation acquisition unit configured to acquire information indicating at least one of (a) a behavior of another moving object and (b) a road surface condition in a proximity of the vehicle, based on an output signal of a surrounding monitor sensor mounted on the vehicle; and
a standby necessity determination unit configured to determine whether a situation corresponds to a door open standby recommended situation, which is a predetermined situation in which the occupant should wait in standby before opening the door for an appropriate moment, based on information indicating a behavior of another moving object acquired by the outside-vehicle situation acquisition unit at a timing when the hop-off action detection unit detects the hop-off action, wherein
the display processing unit is configured to display, in the display area positioned in the sight line direction of the occupant, text or an image showing a reason for standby or recommending a wait in standby before opening the door based on a determination by the standby necessity determination unit that the situation corresponds to the door open standby recommended situation.

12. The information presentation device according to claim 11, wherein
when the standby necessity determination unit determines that there is no longer a need to wait in standby before opening the door after output of text or an image recommending a wait in standby before opening the door, the display processing unit is configured to display, in the display area corresponding to the sight line direction of the occupant, an image indicating (a) that the reason for standby has disappeared or (b) that the door may be opened.

13. The information presentation device according to claim 1, further comprising:
a wind force acquisition unit configured to acquire a strength of wind outside the vehicle, wherein
when the strength of the wind acquired by the wind force acquisition unit is equal to or higher than a predetermined strong wind threshold value, the display processing unit is configured to display, in the display area positioned in the sight line direction of the occupant, text or an image indicating that the wind is strong when the hop-off action detection unit detects the hop-off action.

14. An information presentation device configured to select at least one area from among a plurality of display areas where information is to be displayed to an occupant of a predetermined seat provided in a vehicle, the plurality of display areas including at least a door display area on a door adjacent to the seat, the information presentation device comprising:
a storage configured to store schedule information of the occupant; and
a processor configured to
display, in at least one of the plurality of display areas, information related to a situation outside the vehicle,
acquire information indicating a sight line direction of the occupant,
detect a hop-off action of the occupant,
determine whether a predetermined notification target event exists in a hop-off spot, which is an area of a road surface within a predetermined distance from the door, based on an image of a camera that is configured to capture an outside of the vehicle,
change, according to the sight line direction of the occupant, a display position of information related to the situation outside the vehicle,
determine, when the notification target event is determined to exist in the hop-off spot, whether the occupant has time to spare based on the schedule information, and
when the notification target event is determined to exist in the hop-off spot,
display, in a display area positioned in the sight line direction of the occupant, text or an image proposing to change a parking position, when determining that the occupant has time to spare, or
display, in the display area, text or an image indicating a content of the notification target event, when not determining that the occupant has time to spare.
